(19) United States
(12) Patent Application Publication
(10) Pub. No.: US 2017/0192217 A1
(43) Pub. Date: Jul. 6, 2017

(54) OPTICAL-AXIS-DIRECTION SCANNING MICROSCOPE APPARATUS

(71) Applicant: OLYMPUS CORPORATION, Tokyo (JP)

(72) Inventor: Hiroya FUKUYAMA, Tokyo (JP)

(73) Assignee: OLYMPUS CORPORATION, Tokyo (JP)

(21) Appl. No.: 15/467,049

(22) Filed: Mar. 23, 2017

Related U.S. Application Data
(63) Continuation of application No. PCT/JP2015/078100, filed on Oct. 2, 2015.

(30) Foreign Application Priority Data
Oct. 3, 2014 (JP) 2014-204423

(51) Int. Cl. G02B 21/00; G02B 27/00

(52) U.S. Cl. CPC G02B 21/0072; G02B 27/0068; G02B 21/0032; G02B 21/0044

(57) ABSTRACT

An optical-axis-direction scanning microscope apparatus includes: a light source; an illumination optical system for irradiating an examination object with illumination light from the light source; an image-forming optical system for collecting light from the examination object; and an image-capturing element (photodetector) that captures the light which is collected to acquire an image. Provided are: a plurality of image-forming lenses for forming a final image and at least one intermediate image; a first phase modulation element that is placed towards an object from one of the intermediate images and that imparts a spatial disturbance to the wavefront of the light from the object; and a second phase modulation element that is placed at a position, between that position and the first phase modulation element being at least one intermediate image, and that cancels out the spatial disturbance which is imparted to the wavefront of the light from the object.

### CROSS-REFERENCE TO RELATED APPLICATIONS

This is a continuation of International Application PCT/JP2015/078100 which is hereby incorporated by reference herein in its entirety.

This application is based on Japanese Patent Application No. 2014-204423, the contents of which are incorporated herein by reference.

### TECHNICAL FIELD

The present invention relates to, for example, an optical-axis-direction scanning microscope apparatus for performing optical scanning in the optical axis direction.

### BACKGROUND ART

There is a known method for moving a focal position in an object of interest along the optical axis direction (Z-axis direction) by adjusting the optical-path length at an intermediate-image position (refer to, for example, Patent Literature 1 and Patent Literature 2 below).

### CITATION LIST

### Patent Literature

### {PTL 1}

Publication of Japanese Patent No. 4011704

### {PTL 2}

Japanese Translation of PCT International Application, Publication No. 2010-513968

### SUMMARY OF INVENTION

One aspect of the present invention is an optical-axis-direction scanning microscope apparatus including: an image-forming optical system including a plurality of image-forming lenses that form a final image and at least one intermediate image, a first phase modulation element that is placed towards an object from one of the intermediate images formed by the image-forming lenses and that imparts a spatial disturbance to a wavefront of light from the object, and a second phase modulation element that is placed at a position, between the position and the first phase modulation element being at least one intermediate image, and that cancels out the spatial disturbance imparted by the first phase modulation element to the wavefront of the light from the object; and a scanning system that scans, in an optical axis direction, an image formed as a result of the wavefront from the object passing through the image-forming optical system.

### BRIEF DESCRIPTION OF DRAWINGS

FIG. 1 is a schematic diagram showing one embodiment of an image-forming optical system used for a microscope apparatus according to the present invention.

FIG. 2 is a schematic diagram for illustrating the operation of the image-forming optical system in FIG. 1.

FIG. 3 is a magnified view showing the section from the pupil position on the object side to the wavefront-restoring element in FIG. 2.

FIG. 4 is a schematic diagram showing an image-forming optical system used for a conventional microscope apparatus.

FIG. 5 is schematic diagram showing an observation apparatus according to a first embodiment of the present invention.

FIG. 6 is a schematic diagram showing an observation apparatus according to a second embodiment of the present invention.

FIG. 7 is a schematic diagram showing an observation apparatus according to a third embodiment of the present invention.

FIG. 8 is a schematic diagram showing a modification of the observation apparatus in FIG. 7.

FIG. 9 is a schematic diagram showing a first modification of the observation apparatus in FIG. 8.

FIG. 10 is a schematic diagram showing a further modification of the observation apparatus in FIG. 9.

FIG. 11 is a schematic diagram showing a second modification of the observation apparatus in FIG. 8.

FIG. 12 is a schematic diagram showing a third modification of the observation apparatus in FIG. 8.

FIG. 13 is a perspective view showing cylindrical lenses serving as one example of phase modulation elements used for an image-forming optical system and an observation apparatus according to the present invention.

FIG. 14 is a schematic diagram for illustrating the operation in a case where the cylindrical lenses in FIG. 13 are used.

FIG. 15 is a diagram for illustrating the relationship between the amount of phase modulation and optical power on the basis of Gaussian optics used for the explanation of FIG. 14.

FIG. 16 is a perspective view showing binary diffraction gratings serving as another example of phase modulation elements used for an image-forming optical system and an observation apparatus according to the present invention.

FIG. 17 is a perspective view showing one-dimensional sine-wave diffraction gratings serving as another example of phase modulation elements used for an image-forming optical system and an observation apparatus according to the present invention.

FIG. 18 is a perspective view showing free curved surface lenses serving as another example of phase modulation elements used for an image-forming optical system and an observation apparatus according to the present invention.

FIG. 19 is a longitudinal sectional view showing cone lenses serving as another example of phase modulation elements used for an image-forming optical system and an observation apparatus according to the present invention.

FIG. 20 is a perspective view showing concentric binary diffraction gratings serving as another example of phase modulation elements used for an image-forming optical system and an observation apparatus according to the present invention.

FIG. 21 is a schematic diagram for illustrating the behavior of a ray along the optical axis in a case where diffraction gratings are used as phase modulation elements.

FIG. 22 is a schematic diagram for illustrating the behavior of an on-axis ray in a case where diffraction gratings are used as phase modulation elements.

FIG. 23 is a detailed view of a central part for illustrating the operation of a diffraction grating functioning as a wavefront-disturbing element.

FIG. 24 is a detailed view of a central part for illustrating the operation of a diffraction grating functioning as a wavefront-restoring element.

FIG. 25 is a longitudinal sectional view showing spherical aberration elements serving as another example of phase modulation elements used for an image-forming optical system and an observation apparatus according to the present invention.

FIG. 26 is a longitudinal sectional view showing irregular shape elements serving as another example of phase modulation elements used for an image-forming optical system and an observation apparatus according to the present invention.

FIG. 27 is a schematic diagram showing a reflective phase modulation element serving as another example of a phase modulation element used for an image-forming optical system and an observation apparatus according to the present invention.

FIG. 28 is a schematic diagram showing gradient index elements serving as another example of phase modulation elements used for an image-forming optical system and an observation apparatus according to the present invention.

FIG. 29 is a diagram showing one example of a lens array in a case where an image-forming optical system according to the present invention is applied to an apparatus for microscopically displaying a magnified view for examination for endoscopic use.

FIG. 30 is a diagram showing one example of a lens array in a case where an image-forming optical system according to the present invention is applied to a microscope provided with an endoscopic small-diameter objective lens with an inner focus function.

FIG. 31A is a schematic diagram of an image-forming optical system in which a wavefront-disturbing element and a wavefront-restoring element are arranged so as to hold a conjugate positional relationship, as viewed from the direction in which the refractive power of the cylindrical lenses acts.

FIG. 31B is a schematic diagram of FIG. 31A as viewed from the direction in which the refractive power of the cylindrical lenses does not act.

FIG. 32A is a schematic diagram of an image-forming optical system in which a wavefront-disturbing element and a wavefront-restoring element are arranged so as to hold a non-conjugate positional relationship, as viewed from the direction in which the refractive power of the cylindrical lenses acts.

FIG. 32B is a schematic diagram of FIG. 32A as viewed from the direction in which the refractive power of the cylindrical lenses does not act.

FIG. 33A is a schematic diagram of an image-forming optical system in which a wavefront-disturbing element and a wavefront-restoring element are arranged so as to hold another non-conjugate positional relationship, as viewed from the direction in which the refractive power of the cylindrical lenses acts.

FIG. 33B is a schematic diagram of FIG. 33A as viewed from the direction in which the refractive power of the cylindrical lenses does not act.

FIG. 34 is a cross-sectional view showing an aspect-ratio conversion optical system of an image-forming optical system according to a modification of the present invention.

FIG. 35 is a schematic diagram showing an aspect-ratio conversion mechanism of an image-forming optical system according to a modification of the present invention.

FIG. 36 is a schematic diagram showing an aspect-ratio conversion circuit of an image-forming optical system according to a modification of the present invention.

FIG. 37 is a diagram showing one example of images before and after being corrected by an aspect-ratio correction circuit.

FIG. 38 is a schematic diagram showing a parallel plate of a microscope with which an image-forming optical system according to the present invention is combined.

FIG. 39 is a schematic diagram showing an observation apparatus according to one embodiment of the present invention.

FIG. 40 is a plan view showing an illuminating device in FIG. 39.

FIG. 41 is a side elevational view showing the illuminating device in FIG. 39.

FIG. 42 is a cross-sectional view showing a light-beam travel position in the wavefront-restoring element in FIG. 39, resulting from a scanning operation.

FIG. 43 is a cross-sectional view showing a light-beam travel position at the pupil position of the objective lens in FIG. 39, resulting from the scanning operation.

FIG. 44 is a magnified schematic diagram showing a part of an illuminating device according to an embodiment of the present invention.

### DESCRIPTION OF EMBODIMENTS

One embodiment of an image-forming optical system 1 used for a microscope apparatus (optical-axis-direction scanning microscope apparatus) according to the present invention will now be described with reference to the drawings.

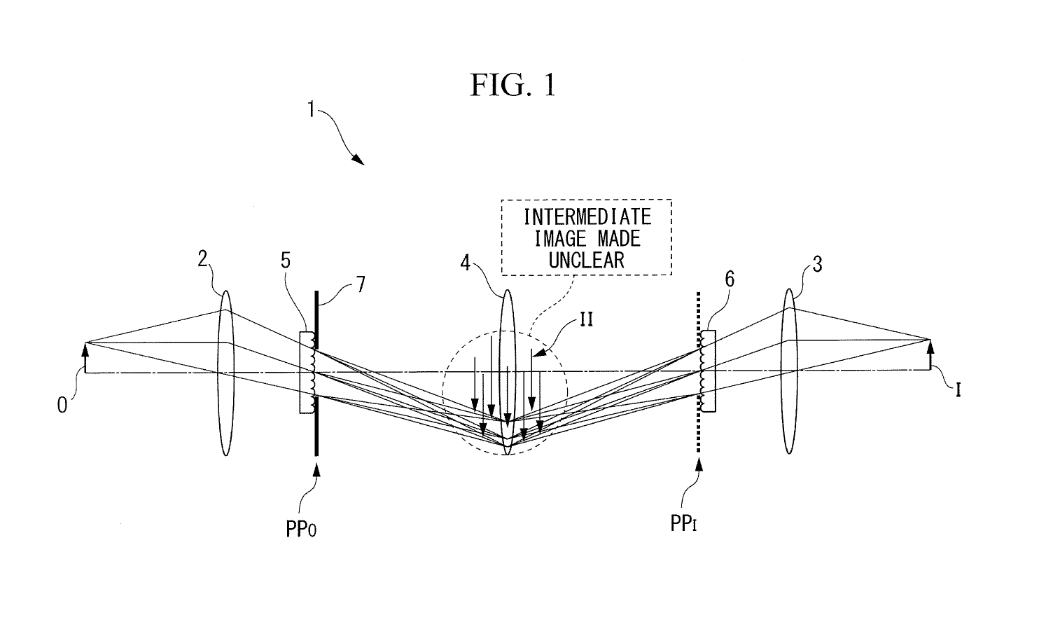

As shown in FIG. 1, the image-forming optical system 1 according to this embodiment includes: two image-forming lenses 2 and 3 constituting one pair arranged with a space therebetween; a field lens 4 placed on the intermediate-image forming planes of these image-forming lenses 2 and 3; a wavefront-disturbing element (first phase modulation element) 5 placed in the vicinity of a pupil position PP_{O} of the image-forming lens 2 on an object O side; and a wavefront-restoring element (second phase modulation element) 6 placed in the vicinity of a pupil position PP_{I} of the image-forming lens 3 on an image I side. Reference sign 7 in the figure denotes an aperture stop.

When transmitting light that has been emitted from the object O and that has been focused by the image-forming lens 2 on the object O side, the wavefront-disturbing element 5 imparts a disturbance to the wavefront. As a result of the disturbance being imparted to the wavefront by the wavefront-disturbing element 5, the intermediate image formed on the field lens 4 is made unclear.

On the other hand, when transmitting the light that has been focused by the field lens 4, the wavefront-restoring element 6 imparts to the light a phase modulation that cancels out the disturbance on the wavefront imparted by the wavefront-disturbing element 5. The wavefront-restoring element 6 has opposite phase characteristics from those of the wavefront-disturbing element 5 and forms the clear final image I by canceling out the disturbance on the wavefront.

A more general concept of the image-forming optical system 1 according to this embodiment will be described below in detail.

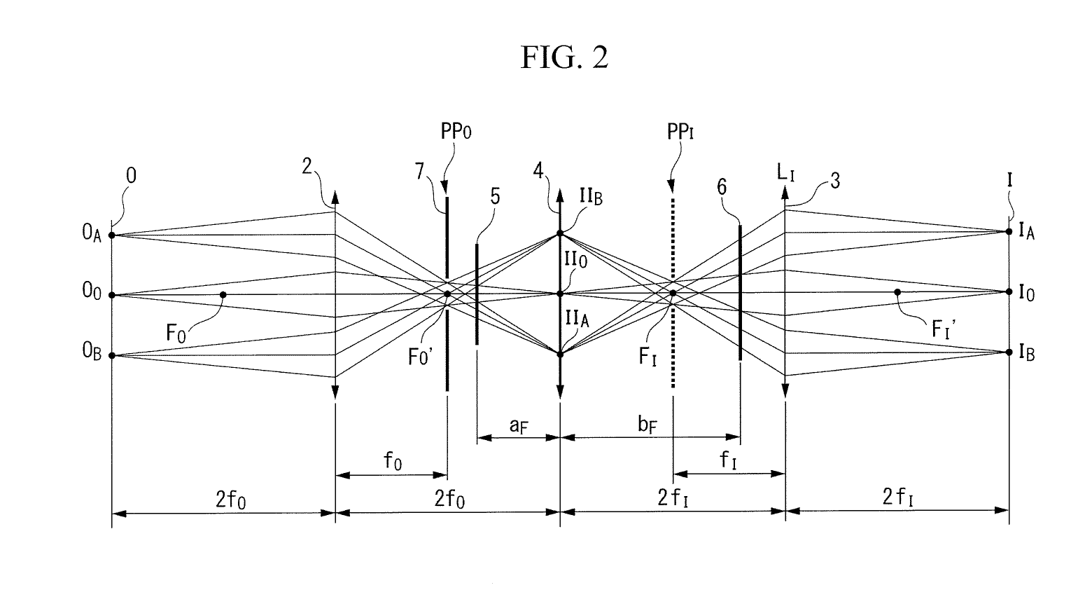

In the example shown in FIG. 2, the image-forming optical system 1 is arranged telecentrically with respect to the object O side and the image I side. Furthermore, the wavefront-disturbing element 5 is placed at a position a distance a_{F} away from the field lens 4 towards the object O, and the wavefront-restoring element 6 is placed at a position a distance b_{F} away from the field lens 4 towards the image I.

In FIG. 2, reference sign f₀ denotes the focal length of the image-forming lens 2, reference sign f_{I} denotes the focal length of the image-forming lens 3, reference signs F_{O} and F_{O}′ denote the focal positions of the image-forming lens 2, reference signs F_{I} and F_{I}′ denote the focal positions of the image-forming lens 3, and reference signs II₀, II_{A}, and II_{B} denote intermediate images.

Here, the wavefront-disturbing element 5 does not necessarily need to be placed in the vicinity of the pupil position PP_{O} of the image-forming lens 2, and the wavefront-restoring element 6 does not necessarily need to be placed in the vicinity of the pupil position PP_{I} of the image-forming lens 3.

Nonetheless, it is necessary that the wavefront-disturbing element 5 and the wavefront-restoring element 6 be placed at mutually conjugate positions for image formation with the field lens 4, as indicated by Expression (1).

1/f_{F}=1/a_{F}+1/b_{F} (1)

Here, f_{F} is the focal length of the field lens 4.

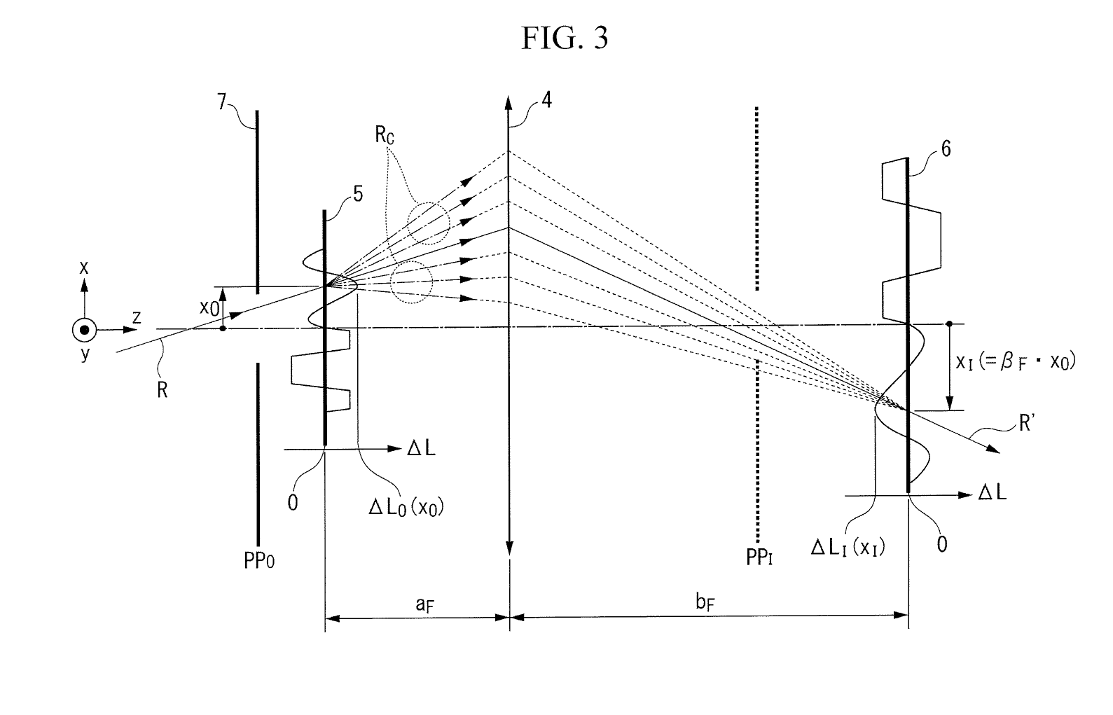

FIG. 3 is a diagram showing details of the section from the pupil position PP_{O} on the object O side to the wavefront-restoring element 6 in FIG. 2.

In the figure, ΔL is the amount of phase lead, relative to a ray passing through a particular position (i.e., ray height), that is imparted as a result of light passing through the optical elements.

Also, ΔLₒ(xₒ) is a function for providing the amount of phase lead of light that passes through an arbitrary ray height x_{O} at the wavefront-disturbing element 5, relative to the light that passes through the optical axis (x=0) at the wavefront-disturbing element 5.

Furthermore, ΔL_{I}(x_{I}) is a function for providing the amount of phase lead of light that passes through an arbitrary ray height x_{I} at the wavefront-restoring element 6, relative to the light that passes through the optical axis (x=0) at the wavefront-restoring element 6.

ΔL_{O}(x_{O}) and ΔL_{I}(x_{I}) satisfy Expression (2) below.

ΔL_{O}(x_{O})+ΔL_{I}(x_{I})=ΔL_{O}(x_{O})+ΔL_{I}(β_{F}·x_{O})=0 (2)

Here, β_{F} is the lateral magnification due to the field lens 4 in the conjugate relationship between the wavefront-disturbing element 5 and the wavefront-restoring element 6, and is represented by Expression (3) below.

β_{F}=−b_{F}/a_{F} (3)

When one ray R enters the image-forming optical system 1 as described above and passes through a position x_{O} at the wavefront-disturbing element 5, the ray is subjected to phase modulation of ΔL_{O}(x_{O}) at that position, producing a disturbed ray Rc due to refraction, diffraction, scattering, and so forth. The disturbed ray Rc is projected by the field lens 4 to a position x_{I}=β_{F}·x_{O} on the wavefront-restoring element 6 together with the components of the ray R that have not been subjected to phase modulation. As a result of passing through this position, the projected ray is subjected to phase modulation of ΔL_{I}(β_{F}·x_{O})=−ΔL_{O}(x_{O}), whereby the phase modulation applied by the wavefront-disturbing element 5 is cancelled out. By doing so, one ray R′ free of wavefront disturbance is restored.

If the wavefront-disturbing element 5 and the wavefront-restoring element 6 hold a conjugate positional relationship and have the characteristics represented by Expression (2), then it is assured that the ray that has been subjected to phase modulation via one position on the wavefront-disturbing element 5 passes through a particular position on the wavefront-restoring element 6, namely, the particular position that corresponds in a one-to-one manner to the one position and via which a phase modulation is imparted to cancel out the phase modulation applied by the wavefront-disturbing element 5. The optical systems shown in FIGS. 2 and 3 operate as described above in response to the ray R, regardless of the incidence position x_{O} or the incidence angle of the ray R on the wavefront-disturbing element 5. In short, the intermediate images II can be made unclear, and the final image I can be formed clearly in response to any ray R.

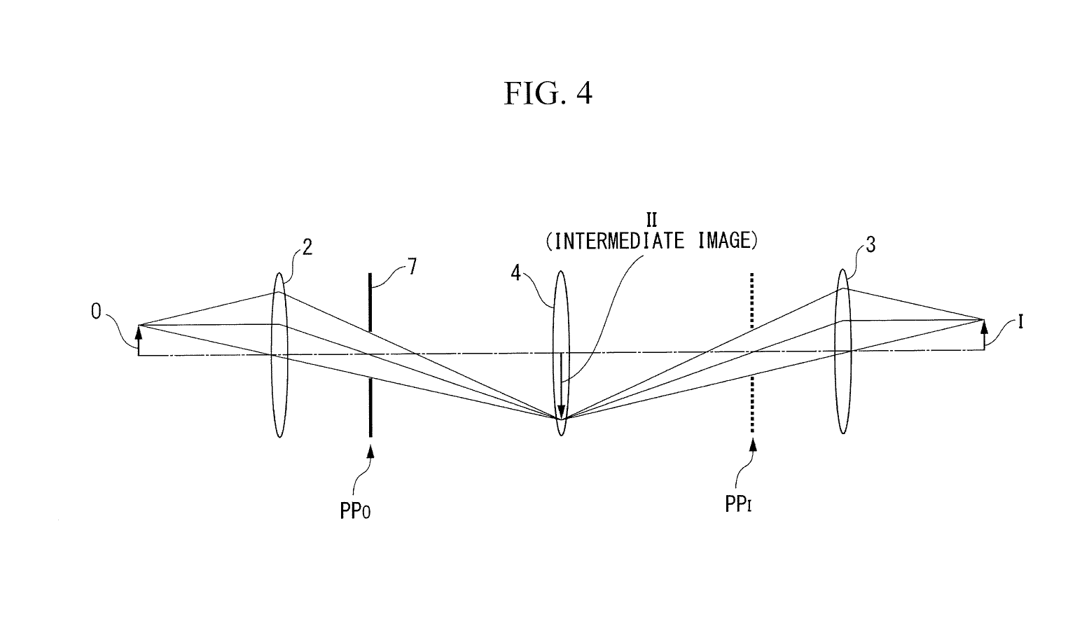

FIG. 4 shows a conventional image-forming optical system. According to this image-forming optical system, the light focused by the image-forming lens 2 on the object O side forms the clear intermediate images II on the field lens 4 placed on the intermediate-image forming plane and is then focused by the image-forming lens 3 on the image I side, thus forming the clear final image I.

The conventional image-forming optical system has a drawback in that if there is a flaw, dust, or the like on the surface of the field lens 4 or any defect, such as a hollow cavity, in the field lens 4, then the image of the foreign object overlaps an intermediate image clearly formed on the field lens 4, thereby forming the image of the foreign object on the final image I.

In contrast, according to the image-forming optical system 1 of this embodiment, because the intermediate images II that have been made unclear by the wavefront-disturbing element 5 are formed on the intermediate-image forming plane placed at the position corresponding to the field lens 4, the image of the foreign object overlapping the intermediate images II are made unclear due to a phase modulation by the wavefront-restoring element 6 when the unclear intermediate images II are made clear by the same phase modulation. Therefore, the image of the foreign object on the intermediate-image forming plane can be prevented from overlapping the clear final image I.

Although the two image-forming lenses 2 and 3 have been described as being arranged telecentrically, they are not limited to this arrangement. The same effect can also be achieved with a non-telecentric system.

In addition, although the function for the amount of phase lead has been described as a one-dimensional function, the same effect can also be achieved with a two-dimensional function.

Furthermore, the spaces between the image-forming lens 2, the wavefront-disturbing element 5, and the field lens 4, as well as the spaces between the field lens 4, the wavefront-restoring element 6, and the image-forming lens 3, are not necessarily required. The spaces between these elements may be optically bonded.

Furthermore, although the image forming function and the pupil relaying function have been separately assigned to the lenses constituting the image-forming optical system 1, namely, the image-forming lenses 2 and 3 and the field lens 4, in the actual image-forming optical system, one lens may have both the image forming function and the pupil relaying function simultaneously. Also in such a case, the wavefront-disturbing element 5 can impart a disturbance to the wavefront to make the intermediate images II unclear, and the wavefront-restoring element 6 can cancel out the disturbance on the wavefront to make the final image I clear, provided that the above-described conditions are satisfied.

An observation apparatus (optical-axis-direction scanning microscope apparatus) 10 according to a first embodiment of the present invention will be described below with reference to the drawings.

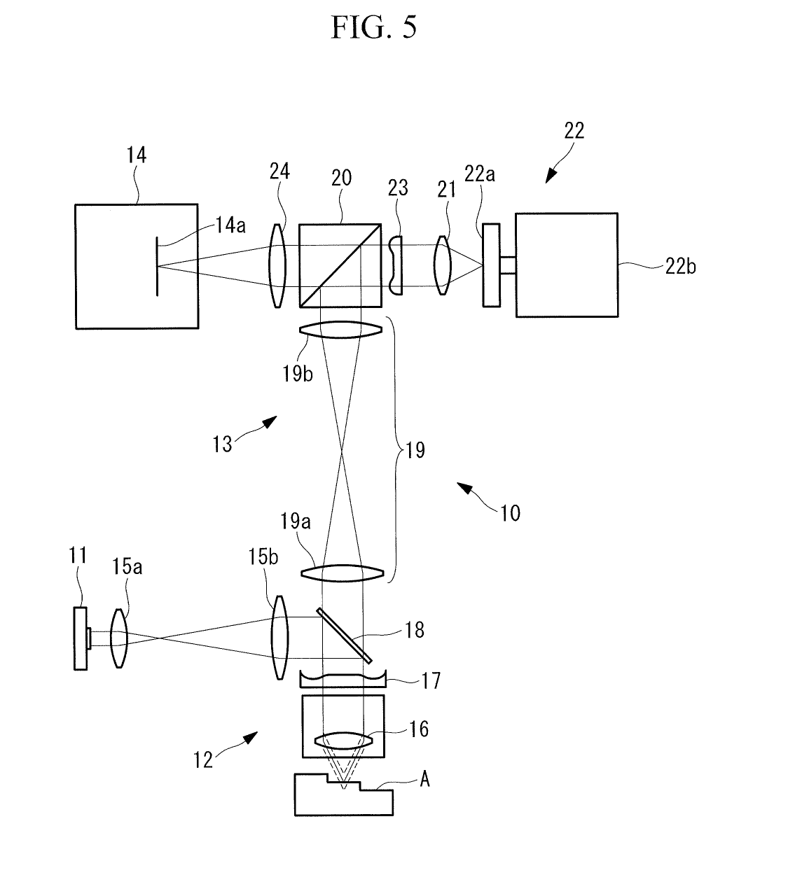

As shown in FIG. 5, the observation apparatus 10 according to this embodiment includes: a light source 11 for generating non-coherent illumination light; an illumination optical system 12 for irradiating an examination object A with illumination light from the light source 11; an image-forming optical system 13 for collecting the light from the examination object A; and an image-capturing element (photodetector) 14 that captures the light collected by the image-forming optical system 13 to acquire an image.

The illumination optical system 12 includes: focusing lenses 15a and 15b for focusing the illumination light from the light source 11; and an objective lens 16 for irradiating the examination object A with the illumination light focused by the focusing lenses 15a and 15b.

Furthermore, this illumination optical system 12 is so-called Koehler illumination, and the focusing lenses 15a and 15b are arranged so that the light emission plane of the light source 11 and the pupil plane of the objective lens 16 are mutually conjugate.

The image-forming optical system 13 includes: the above-described objective lens (image-forming lens) 16 for collecting observation light (e.g., reflected light) emitted from the examination object A placed on the object side; a wavefront-disturbing element 17 for imparting a disturbance to the wavefront of the observation light collected by the objective lens 16; a first beam splitter 18 for splitting off the light the wavefront of which has been subjected to disturbance from the illumination light path continuing from the light source 11; a first pair of intermediate-image forming lenses 19 arranged with a space therebetween in the optical axis direction; a second beam splitter 20 that deflects by 90° the light having passed through each of lenses 19a and 19b of the first pair of intermediate-image forming lenses 19; a second intermediate-image forming lens 21 that focuses the light deflected by the second beam splitter 20 to form an intermediate image; optical-path-length changing means 22 placed on the intermediate-image forming plane due to the second intermediate-image forming lens 21; a wavefront-restoring element 23 placed between the second beam splitter 20 and the second intermediate-image forming lens 21; and an image-forming lens 24 that focuses the light passing through the wavefront-restoring element 23 and the second beam splitter 20 to form a final image.

The image-capturing element 14 is a two-dimensional image sensor, such as a CCD or a CMOS, is provided with an image-capturing plane 14a placed at the image-forming position of the final image due to the image-forming lens 24, and is capable of acquiring a two-dimensional image of the examination object A by capturing the incident light.

The wavefront-disturbing element 17 is placed in the vicinity of the pupil position of the objective lens 16. The wavefront-disturbing element 17 is composed of an optically transparent material that can transmit light, and when transmitting light, it imparts, to the wavefront of the light, a phase modulation in accordance with the uneven shape on its surface. In this embodiment, it is configured to impart the necessary wavefront disturbance by transmitting the observation light from the examination object A once.

Furthermore, the wavefront-restoring element 23 is placed in the vicinity of the pupil position of the second intermediate-image forming lens 21. The wavefront-restoring element 23 is also composed of an optically transparent material that can transmit light and is configured to, when transmitting light, impart to the light wavefront a phase modulation in accordance with the uneven shape on its surface. In this embodiment, the wavefront-restoring element 23 is configured to impart, to the wavefront of the observation light, a phase modulation that would cancel out the wavefront disturbance imparted by the wavefront-disturbing element 17 by transmitting the observation light deflected by the second beam splitter 20 and the observation light reflected in a folded manner by the optical-path-length changing means 22, twice in a round trip.

The optical-path-length changing means 22, serving as an optical axis (Z-axis) scanning system, includes a plane mirror 22a placed orthogonal to the optical axis; and an actuator 22b for displacing the plane mirror 22a in the optical axis direction. When the plane mirror 22a is displaced in the optical axis direction through the operation of the actuator 22b of the optical-path-length changing means 22, the optical-path length between the second intermediate-image forming lens 21 and the plane mirror 22a is changed, thereby causing a position in the examination object A conjugate to the image-capturing plane 14a, namely, the focal position in front of the objective lens 16, to be changed in the optical axis direction.

In order to observe the examination object A by the use of the observation apparatus 10 according to this embodiment with this structure, the illumination optical system 12 irradiates the examination object A with the illumination light from the light source 11. The observation light, composed of fluorescence, reflected light, scattered light, and so forth, emitted from the examination object A is collected by the objective lens 16, passes through the wavefront-disturbing element 17 once, then passes through the first beam splitter 18 and the intermediate-image forming lenses 19, is deflected by 90° by the second beam splitter 20, and passes through the wavefront-restoring element 23. Then, the observation light is reflected in a folded manner at the plane mirror 22a of the optical-path-length changing means 22, passes through the wavefront-restoring element 23 again, and passes through the beam splitter 20. By doing so, the final image formed by the image-forming lens 24 is acquired by the image-capturing element 14.

When the actuator 22b of the optical-path-length changing means 22 is operated to move the plane mirror 22a in the optical axis direction, the optical-path length between the second intermediate-image forming lens 21 and the plane mirror 22a can be changed. By doing so, the focal position in front of the objective lens 16 can be moved in the optical axis direction for scanning. Then, a plurality of images focused at different positions in the depth direction of the examination object A can be acquired by capturing an image of the observation light at different focal positions. Furthermore, an image with a large depth of field can be acquired by combining these images through arithmetic averaging and then applying high-band enhancement processing to them.

In this case, an intermediate image due to the second intermediate-image forming lens 21 is formed in the vicinity of the plane mirror 22a of the optical-path-length changing means 22, and this intermediate image is made unclear due to the wavefront disturbance, which was imparted through the wavefront-disturbing element 17 and has remained after being partially canceled out when passing through the wavefront-restoring element 23 a first time. Then, the observation light after forming the unclear intermediate image is focused by the second intermediate-image forming lens 21, and thereafter passes through the wavefront-restoring element 23 a second time, thereby causing the wavefront disturbance to be completely cancelled out.

Consequently, the observation apparatus 10 according to this embodiment affords an advantage in that, even if a foreign object, such as a flaw or dust, exists on the surface of the plane mirror 22a, the image of the foreign object can be prevented from overlapping the final image, thereby making it possible to acquire a clear image of the examination object A.

Furthermore, in the same manner, if the focal position in the examination object A is moved in the optical axis direction, the intermediate image formed by the first pair of intermediate-image forming lenses 19 also varies by a large distance in the optical axis direction, and even though the intermediate image overlaps the position of the first pair of intermediate-image forming lenses 19 as a result of this variation or some optical element exists in the variation area, the image of the foreign object can be prevented from being acquired in a manner whereby it overlaps the final image because the intermediate image is made unclear. In this embodiment, mounting the scanning system as described above ensures that no noise images occur even if light shifts in the Z-axis direction on any optical element placed in the image-forming optical system.

An observation apparatus 30 according to a second embodiment of the present invention will now be described with reference to the drawings.

In the description of this embodiment, parts in common with the structures of the above-described observation apparatus 10 according to the first embodiment are denoted with the same reference signs, and a description thereof will be omitted.

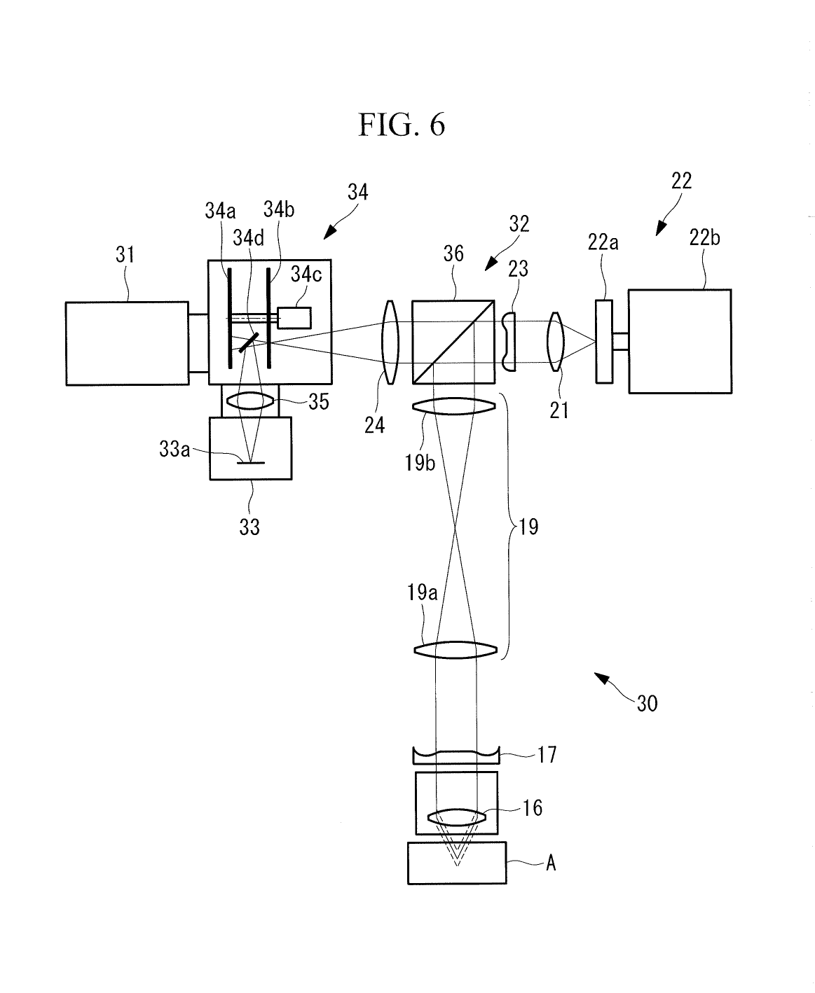

As shown in FIG. 6, the observation apparatus 30 according to this embodiment includes: a laser light source 31; an image-forming optical system 32 that focuses a laser beam from the laser light source 31 on an examination object A and that collects the light from the examination object A; an image-capturing element (photodetector) 33 for capturing the light collected by the image-forming optical system 32; and a Nipkow disk confocal optical system 34 placed between the light source 31 and the image-capturing element 33 and the image-forming optical system 32.

The Nipkow disk confocal optical system 34 includes: two disks 34a and 34b arranged in parallel with a space therebetween; and an actuator 34c for simultaneously rotating those disks 34a and 34b. Many micro lenses (not shown in the figure) are arranged in the disk 34a on the laser light source 31 side, and many pinholes (not shown in the figure) are provided at positions corresponding to the micro lenses in the disk 34b on the object side. Furthermore, a dichroic mirror 34d for splitting off the light having passed through the pinholes is fixed in a space between the two disks 34a and 34b. The light split off by the dichroic mirror 34d is focused by a focusing lens 35, and a final image is formed on an image-capturing plane 33a of the image-capturing element 33, thus acquiring an image.

In the image-forming optical system 32, the first beam splitter 18 and the second beam splitter 20 in the first embodiment are realized by a single beam splitter 36, thereby completely integrating the optical path for irradiating the examination object A with the light passing through the pinholes of the Nipkow disk confocal optical system 34 and the optical path of the light that has been generated in the examination object A and that is incident on the pinholes of the Nipkow disk confocal optical system 34.

The operation of the observation apparatus 30 according to this embodiment with this structure will be described below.

According to the observation apparatus 30 of this embodiment, light that is incident upon the image-forming optical system 32 from the pinholes of the Nipkow disk confocal optical system 34 passes through the beam splitter 36 and a phase modulation element 23, is focused by a second intermediate-image forming lens 21, and is reflected in a folded manner at a plane mirror 22a of an optical-path-length changing means 22. After having passed through the second intermediate-image forming lens 21, the light passes through the phase modulation element 23 again, is deflected by 90° by the beam splitter 36, and is focused onto the examination object A by an objective lens 16 through a first pair of intermediate-image forming lenses 19 and a phase modulation element 17.

In this embodiment, the phase modulation element 23 through which a laser beam passes twice in the beginning functions as a wavefront-disturbing element for imparting a disturbance to the wavefront of the laser beam, and the phase modulation element 17 through which the laser beam subsequently passes once functions as a wavefront-restoring element for imparting a phase modulation that cancels out the wavefront disturbance imparted by the phase modulation element 23.

Therefore, when the light source image formed in the shape of many point light sources through the Nipkow disk confocal optical system 34 is formed by the second intermediate-image forming lens 21 as an intermediate image on the plane mirror 22a, it is possible to prevent the inconvenience that the image of a foreign object existing on the intermediate-image forming plane overlaps the final image, and this is because the intermediate image formed by the second intermediate-image forming lens 21 is made unclear by passing through the phase modulation element 23 once.

Furthermore, because the disturbance imparted to the wavefront by passing through the phase modulation element 23 twice is canceled out by passing through the phase modulation element 17 once, it is possible to form a clear image of the many point light sources in the examination object A. Then, high-speed scanning can be performed by rotating the disks 34a and 34b through the operation of the actuator 34c of the Nipkow disk confocal optical system 34 and moving the image of those many point light sources formed in the examination object A in the XY directions intersecting the optical axis.

On the other hand, light, such as fluorescence, generated at the image-forming positions of the images of the point light sources in the examination object A is collected by the objective lens 16 and passes through the phase modulation element 17 and the first pair of the intermediate-image forming lenses 19. Then, the light is deflected by 90° by the beam splitter 36, passes through the phase modulation element 23, is focused by the second intermediate-image forming lens 21, and is reflected in a folded manner at the plane mirror 22a. Thereafter, the fluorescence is focused again by the second intermediate-image forming lens 21 and passes through the phase modulation element 23 and the beam splitter 36. Then, the fluorescence is focused by an image-forming lens 24 and is formed at the pinhole positions of the Nipkow disk confocal optical system 34.

The light having passed through the pinholes is split off from the optical path continuing from the laser light source by the dichroic mirror, is focused by the focusing lens, and forms a final image at the image-capturing plane of the image-capturing element.

In this case, the phase modulation element 17 transmitting the fluorescence generated in the shape of many spots in the examination object functions as a wavefront-disturbing element in the same manner as in the first embodiment, and the phase modulation element 23 functions as a wavefront-restoring element.

Therefore, as for the fluorescence having a disturbance imparted to the wavefront thereof as a result of passing through the phase modulation element 17, the disturbance is partially canceled out when the fluorescence passes through the phase modulation element 23 once. Thus, the intermediate image formed on the plane mirror 22a is made unclear. Then, the fluorescence whose wavefront disturbance has been completely cancelled out by passing through again the phase modulation element 23 forms an image at the pinholes of the Nipkow disk confocal optical system 34. Then, the light is split off by the dichroic mirror 34d after having passed through the pinholes, is focused by the focusing lens 35, and forms a clear final image at the image-capturing plane 33a of the image-capturing element 33.

Thus, according to the observation apparatus of this embodiment, in the form of not only an illuminating device for irradiating the examination object A with a laser beam but also an observation apparatus for acquiring an image of fluorescence generated in the examination object A, an advantage is afforded in that a clear final image can be acquired while still making the intermediate image unclear to prevent the image of a foreign object on the intermediate-image forming plane from overlapping the final image. In this embodiment, mounting the scanning system as described above ensures that no noise images occur even if light shifts in the Z-axis direction on any optical element placed in the image-forming optical system.

Next, an observation apparatus 40 according to a third embodiment of the present invention will be described with reference to the drawings.

In the description of this embodiment, parts in common with the structures of the above-described observation apparatus 30 according to the second embodiment are denoted with the same reference signs, and a description thereof will be omitted.

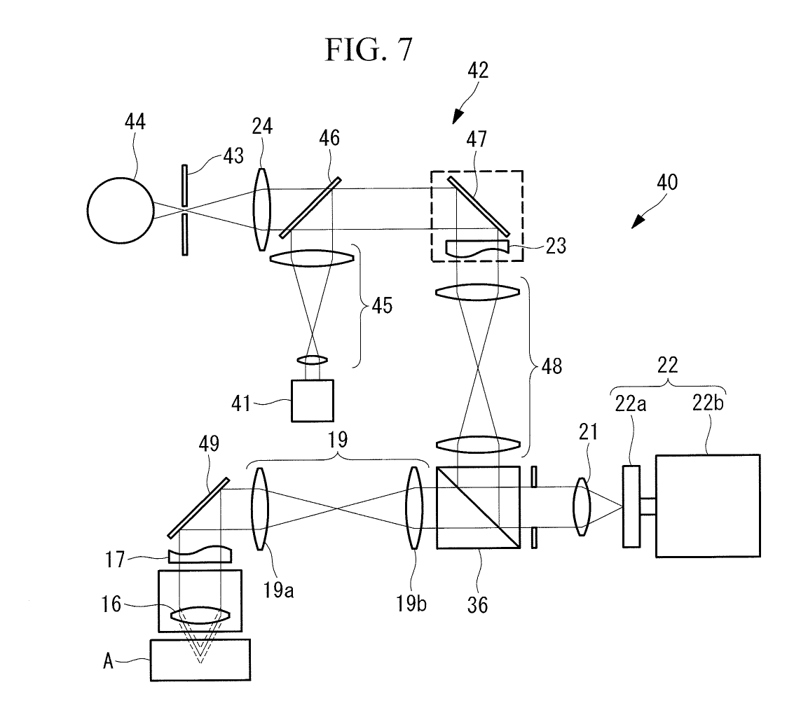

As shown in FIG. 7, the observation apparatus 40 according to this embodiment is a laser-scanning confocal observation apparatus.

This observation apparatus 40 includes: a laser light source 41; an image-forming optical system 42 that focuses a laser beam from the laser light source 41 onto an examination object A and that collects the light from the examination object A; a confocal pinhole 43 transmitting the fluorescence collected by the image-forming optical system 42; and a photodetector 44 for detecting the fluorescence having passed through the confocal pinhole 43.

The image-forming optical system 42 includes, as structures different from those of the observation apparatus 30 according to the second embodiment: a beam expander 45 for magnifying the beam diameter of a laser beam; a dichroic mirror 46 that deflects the laser beam and that transmits fluorescence; a galvanometer mirror 47 placed in the vicinity of a position conjugate to the pupil of an objective lens 16; and a third pair of intermediate-image forming lenses 48. In addition, a phase modulation element 23 for imparting a disturbance to the wavefront of the laser beam is placed in the vicinity of the galvanometer mirror 47. Reference sign 49 in the figure denotes a mirror.

The operation of the observation apparatus 40 according to this embodiment with this structure will be described below.

According to the observation apparatus 40 of this embodiment, a laser beam emitted from the laser light source 41 is magnified by the beam expander 45 in terms of the beam diameter, is deflected by the dichroic mirror 46, is scanned two-dimensionally by the galvanometer mirror 47, and is incident upon a beam splitter 36 through the phase modulation element 23 and the third pair of intermediate-image forming lenses 48.

The laser beam incident on the beam splitter 36 is then incident on a plane mirror 22a of an optical-path-length changing means 22 and forms an intermediate image. Prior to this point, this laser beam has had a disturbance imparted to the wavefront thereof by the phase modulation element 23, and the intermediate image has been made unclear, thereby making it possible to prevent the overlapping of the image of a foreign object existing on the intermediate-image forming plane. Furthermore, because the wavefront disturbance is cancelled out by a phase modulation element 17 placed at the pupil position of the objective lens 16, a final image that has been made clear can be formed in the examination object A. In addition, the image formation depth of the final image can be adjusted freely by the optical-path-length changing means 22.

On the other hand, the fluorescence generated at the image-forming position of the final image of the laser beam in the examination object A is collected by the objective lens 16 and passes through the phase modulation element 17. Thereafter, the fluorescence travels along the opposite optical path of the laser beam and is deflected by the beam splitter 36. Then, the fluorescence is focused at the confocal pinhole 43 by an image-forming lens 24 after having passed through the third pair of intermediate-image forming lenses 48, the phase modulation element 23, the galvanometer mirror 47, and the dichroic mirror 46. Then, only the fluorescence having passed through the confocal pinhole 43 is detected by the photodetector 44.

Also in this case, because the fluorescence collected by the objective lens 16 forms an intermediate image after having the disturbance imparted to the wavefront thereof by the phase modulation element 17, the intermediate image is made unclear, thereby preventing overlapping of the image of a foreign object existing on the intermediate-image forming plane. Then, because the wavefront disturbance is cancelled out through the phase modulation element 23, an image that has been made clear can be formed at the confocal pinhole 43, thereby making it possible to efficiently detect the fluorescence generated at the image-forming position of the final image of the laser beam in the examination object A. As a result, an advantage is afforded in that a bright confocal image with high resolution can be acquired. In this embodiment, mounting the scanning system as described above ensures that no noise images occur even if light shifts in the Z-axis direction on any optical element placed in the image-forming optical system.

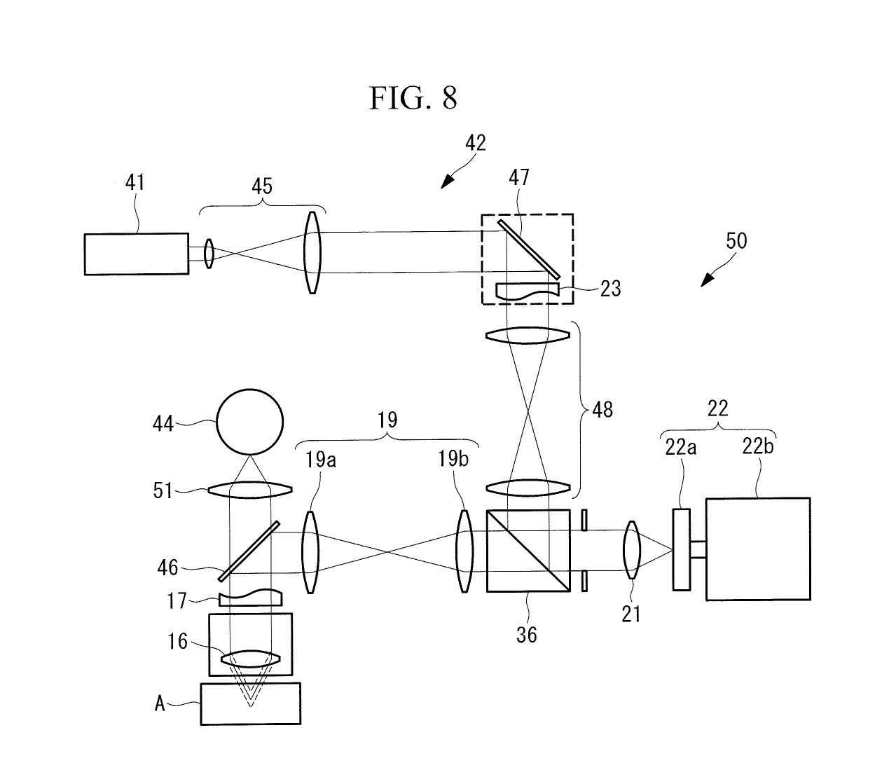

Although this embodiment has been described by way of an example of a laser-scanning confocal observation apparatus, it may instead be applied to a laser-scanning multiphoton-excitation observation apparatus, as shown in FIG. 8.

This can be achieved by employing an ultra-short pulsed laser beam source as the laser light source 41, removing the dichroic mirror 46, and employing the dichroic mirror 46 instead of the mirror 49.

In an observation apparatus 50 in FIG. 8, it is possible to make intermediate images unclear and the final image clear by means of the function of the illuminating device for irradiating the examination object A with an ultra-short pulsed laser beam. As for the fluorescence generated in the examination object A, it is collected by the objective lens 16, is focused by a focusing lens 51 without forming an intermediate image after having passed through the phase modulation element 17 and the dichroic mirror 46, and is detected as is by the photodetector 44.

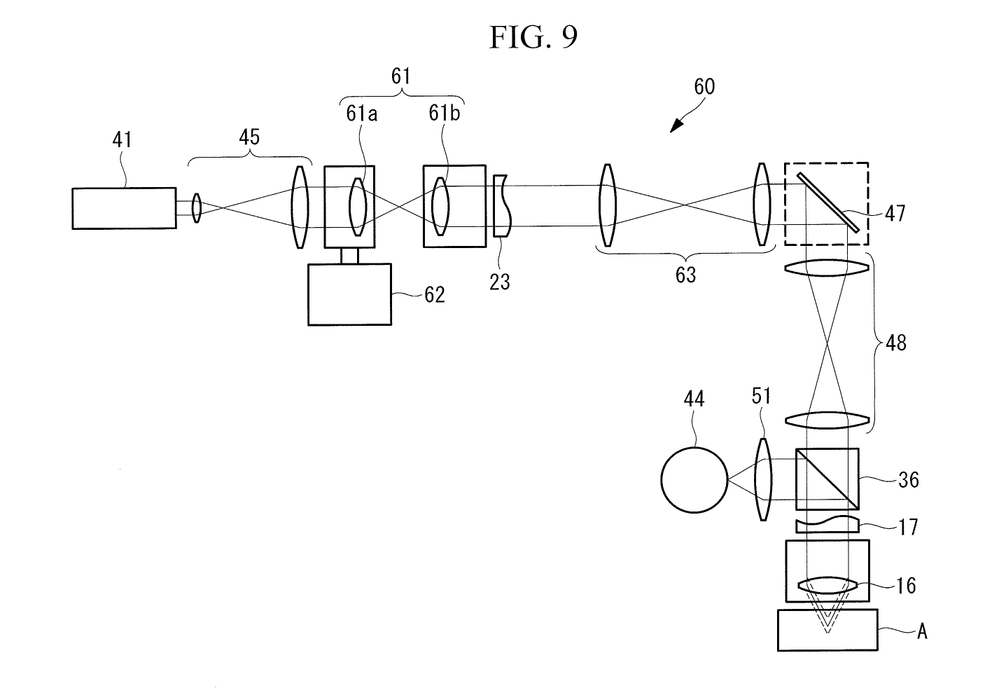

Furthermore, in each of the above-described embodiments, the focal position in front of the objective lens is changed in the optical axis direction with the use of the optical-path-length changing means 22 for changing the optical-path length by moving the plane mirror for folding back the optical path. Instead of this, a structure for changing the optical-path length by moving, with an actuator 62, one lens 61a of lenses 61a and 61b constituting an intermediate-image forming optical system 61 in the optical axis direction may be employed as the optical-path-length changing means, thus configuring an observation apparatus 60 as shown in FIG. 9. Reference sign 63 in the figure denotes another intermediate-image forming optical system.

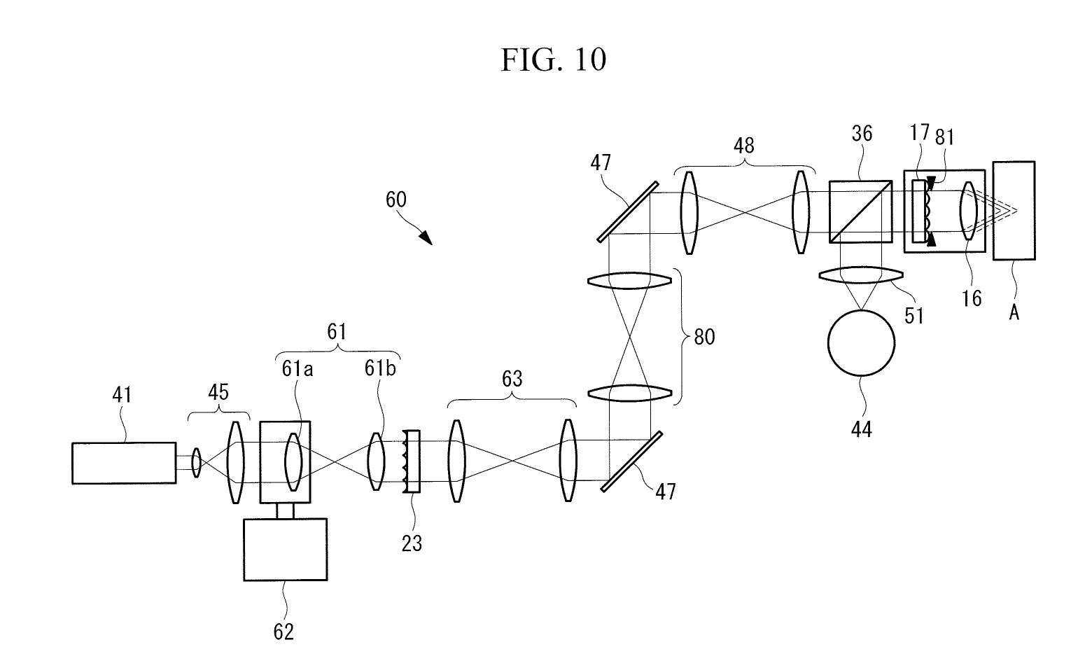

In an alternative structure, as shown in FIG. 10, another intermediate-image forming optical system 80 may be placed between two galvanometer mirrors 47 constituting a two-dimensional optical scanner, such that the two galvanometer mirrors 47 are accurately arranged at optically conjugate positions to the phase modulation elements 17 and 23, as well as to an aperture stop 81 placed at the pupil of the objective lens 16.

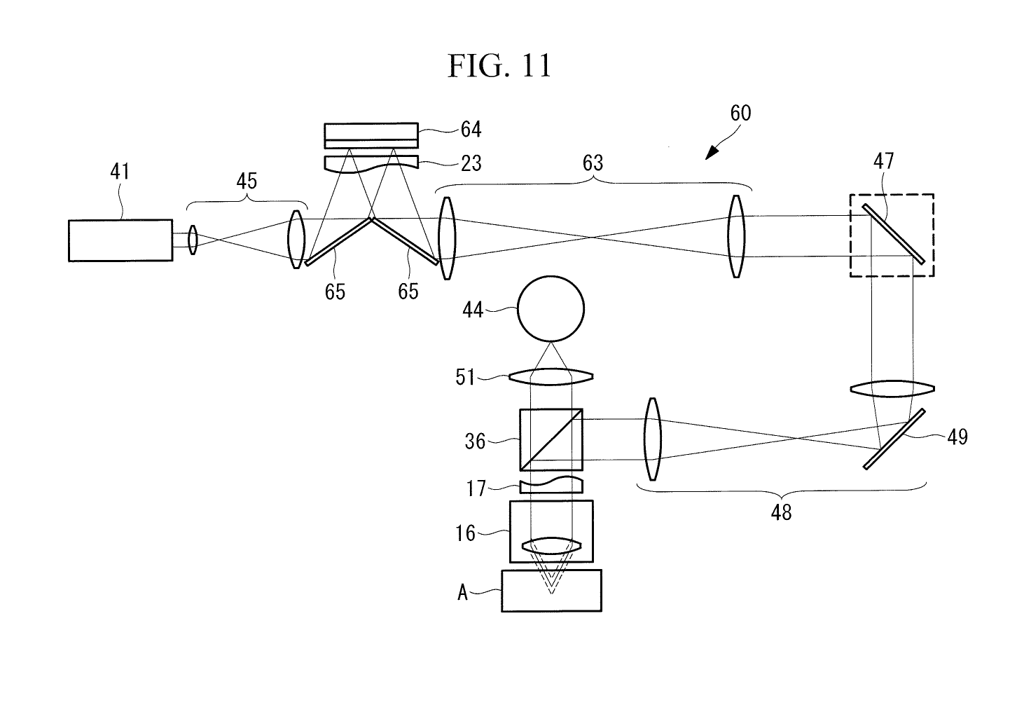

Alternatively, a spatial light modulation element (SLM) 64, like a reflective LCOS, may be employed as the optical-path-length changing means, as shown in FIG. 11. In this manner, the focal position in front of the objective lens 16 can be changed at high speed in the optical axis direction by rapidly changing the phase modulation to be imparted to the wavefront through control of the liquid crystal of the LCOS. Reference sign 65 in the figure denotes a mirror.

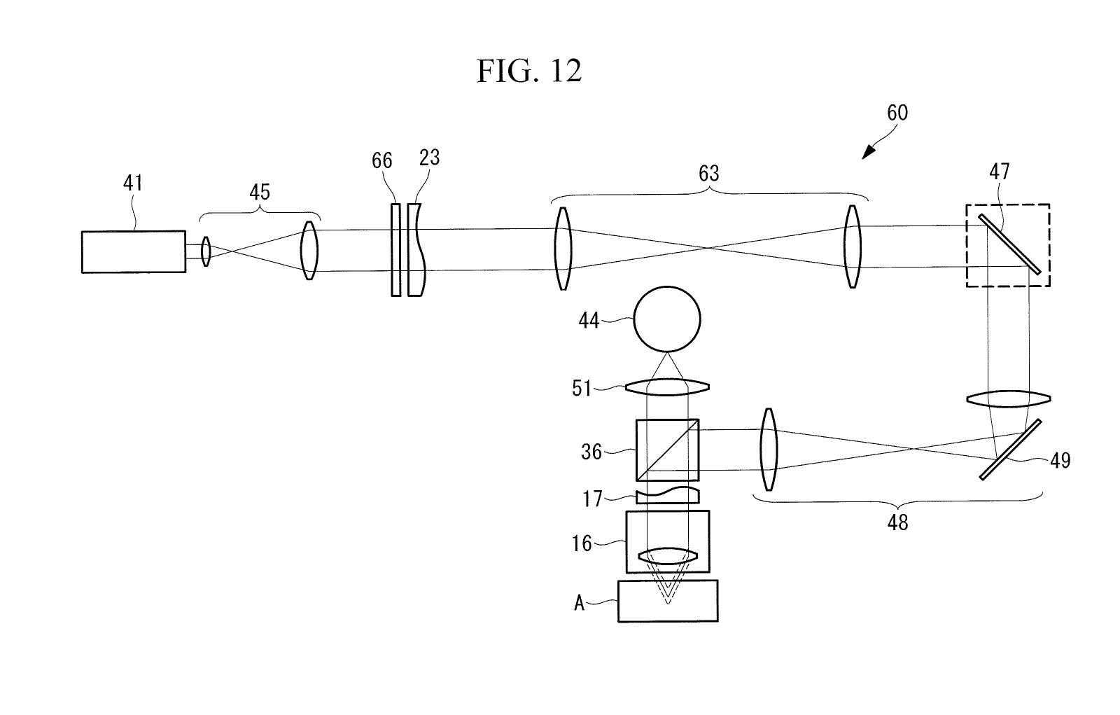

Alternatively, instead of the spatial light modulation element 64 like a reflective LCOS, a spatial light modulation element 66 like a transmissive LCOS may be employed, as shown in FIG. 12. The structure can be made simpler than that of the reflective LCOS because the mirror 65 is not necessary.

As means for moving the focal position in the examination object A in the optical axis direction, various types of well-known variable-power optical elements can be used as active optical elements in addition to those described in each of the above-described embodiments (optical-path-length changing means 22, intermediate-image forming optical system 61 and actuator 62, reflective spatial light modulation element 64, or transmissive spatial light modulation element 66). First, variable optical elements having a mechanically movable part include a shape-variable mirror (DFM: Deformable Mirror) and a shape-variable lens using liquid or gel. Similar variable optical elements not having a mechanically movable part include a liquid crystal lens or a potassium tantalate niobate (KTN: KTa₁₋ₓNbₓO₃) crystal lens, which controls the refractive index of the medium by means of the electric field, and a lens in which the cylindrical lens effect in an acousto-optic deflector (AOD/Acousto-Optical Deflector) is applied.

All the above-described embodiments in the form of a microscope according to the present invention have some means for moving the focal position in the examination object A in the optical axis direction. Furthermore, compared with means for the same purpose (for moving either the objective lens or the examination object in the optical axis direction) in conventional microscopes, these means for shifting the focal position in the optical-axis direction can dramatically increase the moving speed because the mass of the object to be driven is small or because a physical phenomenon with quick response is used.

This affords an advantage in that it is possible to detect a higher-speed phenomenon in an examination object (e.g., living biological tissue specimen).

Furthermore, in a case where the spatial light modulation elements 64 and 66, like a transmissive or reflective LCOS, are to be used, it is possible to make the spatial light modulation elements 64 and 66 carry out the function of the phase modulation element 23. This affords an advantage in that the phase modulation element 23 serving as a wavefront-disturbing element can be omitted, thereby making the structure even simpler.

In the above-described example, the phase modulation element 23 has been omitted in a combination of a spatial light modulation element and a laser-scanning multiphoton-excitation observation apparatus. In the same manner, the phase modulation element 23 can also be omitted in a combination of a spatial light modulation element and a laser-scanning confocal observation apparatus. More specifically, in FIGS. 11 and 12, a dichroic prism 36 is replaced with the mirror 49; a branch optical path is formed by employing the dichroic mirror 46 between the beam expander 45 and the spatial light modulation elements 64 and 66; and the image-forming lens 24, the confocal pinhole 43, and the photodetector 44 are employed, thereby making it possible to cause the spatial light modulation elements 64 and 66 to carry out the function of the phase modulation element 23. The spatial light modulation elements 64 and 66 in this case operate as wavefront-disturbing elements that impart a disturbance to the wavefront in response to a laser beam from the laser light source 41, whereas they operate as a wavefront-restoring element for canceling out the wavefront disturbance imparted by the phase modulation element 17 in response to the fluorescence from the examination object A.

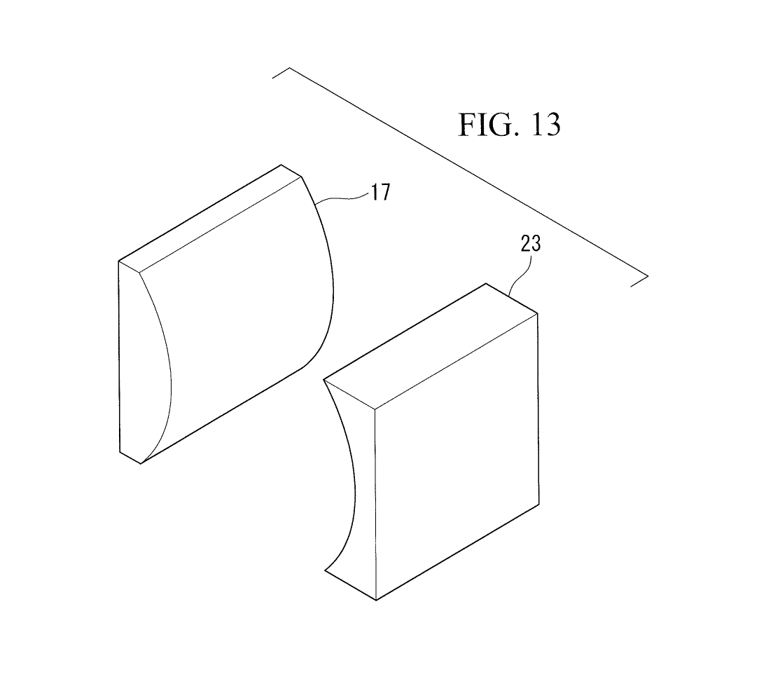

For the phase modulation element, cylindrical lenses 17 and 23, for example, may be employed, as shown in FIG. 13.

In this case, the cylindrical lens 17 causes the intermediate image in the form of a point image to be elongated in a line shape by the effect of astigmatism, thereby making the intermediate image unclear. Then, the final image can be made clear by the use of the cylindrical lens 23 with a shape that is complementary to that of the cylindrical lens 17.

In the case of FIG. 13, either a convex lens or a concave lens may be used as a wavefront-disturbing element and as a wavefront-restoring element.

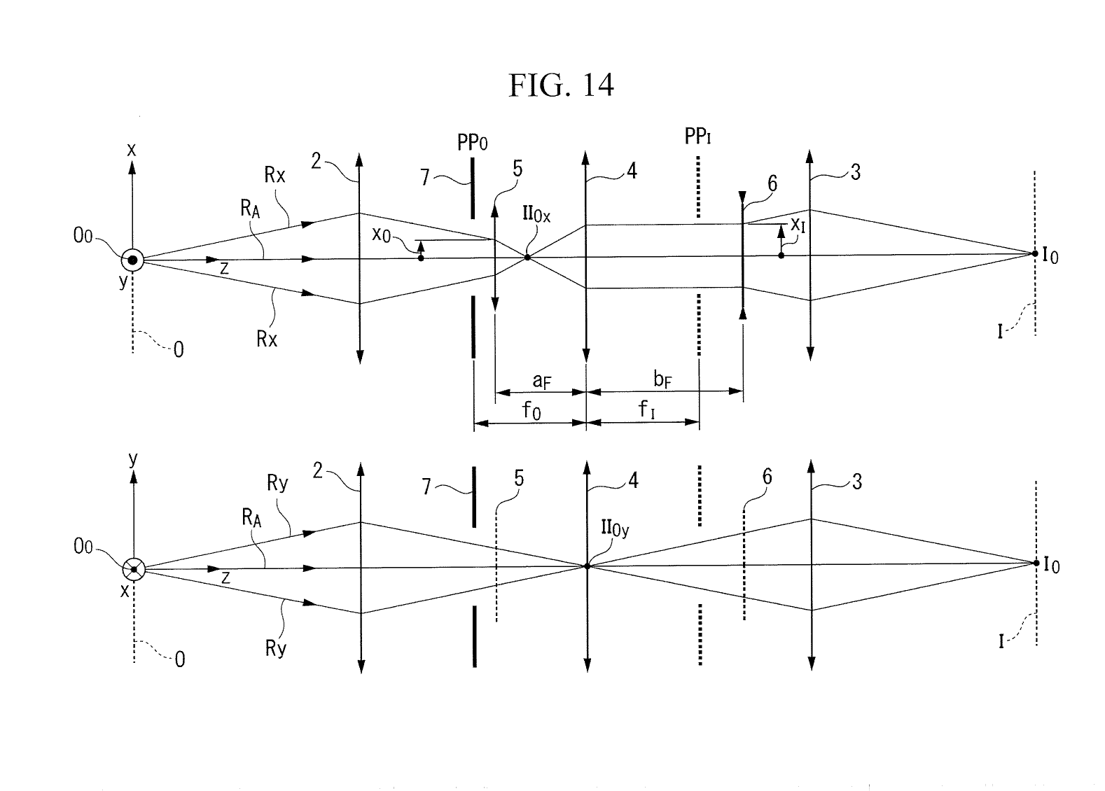

The operation in a case where cylindrical lenses 5 and 6 are used as phase modulation elements will be described in detail below. FIG. 14 illustrates the cylindrical lenses 5 and 6 in a case where they are used as the phase modulation elements in FIGS. 2 and 3.

In this example, the following conditions are set in particular.

(a) A cylindrical lens having refractive power ψOₓ in the x direction is used as the phase modulation element (wavefront-disturbing element) 5 on the object O side.

(b) A cylindrical lens having refractive power ψIₓ in the x direction is used as the phase modulation element (wavefront-restoring element) 6 on the image I side.

(c) Let the position (height of the ray), in the cylindrical lens 5, of an on-axis ray Rₓ on the xz plane be x_{O}.

(d) Let the position (height of the ray), in the cylindrical lens 6, of the on-axis ray Rₓ on the xz plane be x_{I}.

In FIG. 14, reference signs II_{0X} and II_{0Y} denote intermediate images.

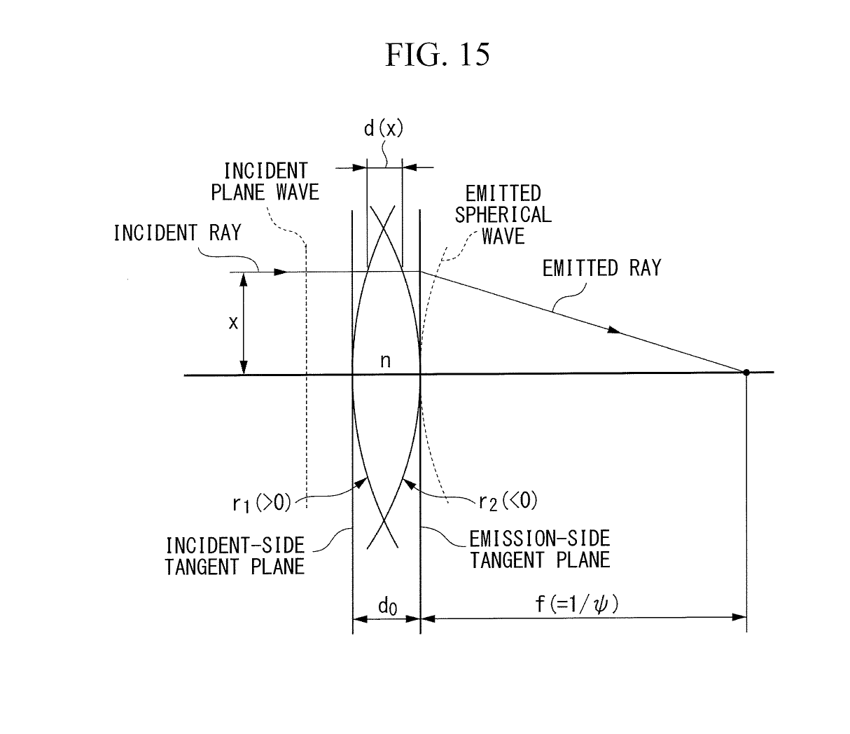

Before the operation in this example is described, the relationship between the amount of phase modulation and optical power based on Gaussian optics will be described with reference to FIG. 15.

Assuming that the thickness of the lens at the height (distance from the optical axis) x is d(x) and that the thickness of the lens at the height 0 (on the optical axis) is d₀ in FIG. 15, the optical-path length L(x) from the incident-side tangent plane to the emission-side tangent plane, along the ray at the height x, is represented by Expression (4) below.

L(x)=(d₀−d(x))+n·d(x) (4)

The difference between the optical-path length L(x) at the height x and the optical-path length L(0) at the height 0 (on the optical axis) is represented by Expression (5) below using the thin lens approximation.

L(x)−L(0)=(−x²/2)(n−1)(1/r₁−1/r₂) (5)

The above-described difference L(x)−L(0) in optical-path length has the same absolute value as, and opposite sign to, the amount of phase lead of emitted light at the height x relative to the emitted light at the height 0. Therefore, the above-described amount of phase lead is represented by Expression (6) below, in which the sign in Expression (5) is reversed.

L(0)−L(x)=(x²/2)(n−1)(1/r₁−1/r₂) (6)

On the other hand, the optical power ψ of this thin lens is represented by Expression (7) below.

ψ=1/f=(n−1)(1/r₁−1/r₂) (7)

Therefore, on the basis of Expressions (6) and (7), the relationship between the amount of phase lead L(0)−L(x) and the optical power it is calculated from Expression (8) below.

L(0)−L(x)=ψ·x²/2 (8)

Now, the description with reference to FIG. 14 will resume.

The amount of phase lead ΔL_{Oc} exerted on the on-axis ray Rₓ on the xz plane in the cylindrical lens 5, relative to the on-axis chief ray, namely, ray R_{A} along the optical axis is represented by Expression (9) below on the basis of Expression (8).

ΔL_{Oc}(x_{O})=L_{Oc}(0)−L_{Oc}(x_{O})=ψOₓ·x_{O}²/2 (9)

Here, L_{Oc}(x_{O}) is a function for the optical-path length from the incident-side tangent plane to the emission-side tangent plane, along the ray of height x_{O} in the cylindrical lens 5.

In the same manner, the amount of phase lead ΔL_{Ic} exerted on the on-axis ray Rx on the xz plane in the cylindrical lens 6, relative to the on-axis chief ray, namely, ray R_{A} along the optical axis, is represented by Expression (10) below.

ΔL_{Ic}(x_{I})=L_{Ic}(0)−L_{Ic}(x_{I})=ψIₓ·x_{I}²/2 (10)

Here, L_{Ic}(x_{I}) is a function for the optical-path length from the incident-side tangent plane to the emission-side tangent plane, along the ray of height x_{I} in the cylindrical lens 6.

By applying Expressions (9) and (10), as well as the relationship (x_{I}/x_{O})2=β_{F}², to Expression (2) shown above, the conditions required for the cylindrical lens 5 to function for wavefront disturbance and for the cylindrical lens 6 to function for wavefront restoration in this example are obtained as shown in Expression (11).

ψ_{Ox}/φ_{Ix}=−β_{F}² (11)

More specifically, the ψ_{Ox} value and the ψ_{Ix} value need to have opposite signs from each other, and the ratio between those absolute values needs to be proportional to the square of the lateral magnification of the field lens 4.

Here, although the description has been given on the basis of the on-axis ray, the cylindrical lenses 5 and 6 also function to disturb and restore the wavefront of an off-axis ray in the same manner, as long as they satisfy the above-described conditions.

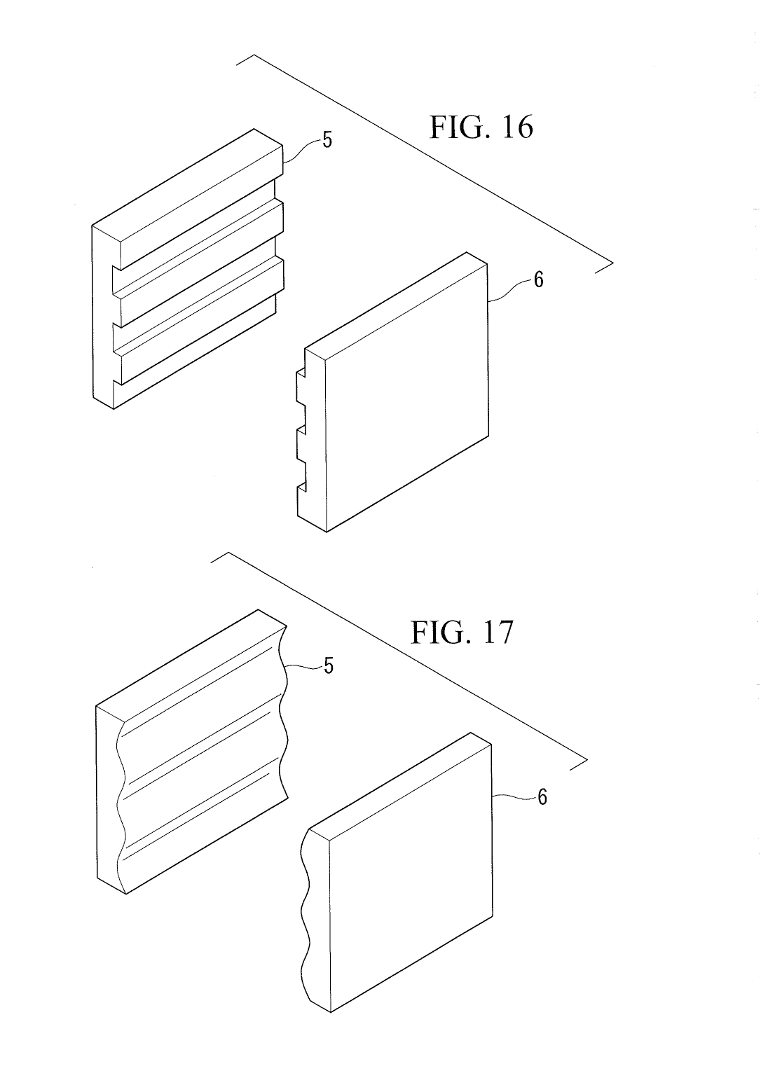

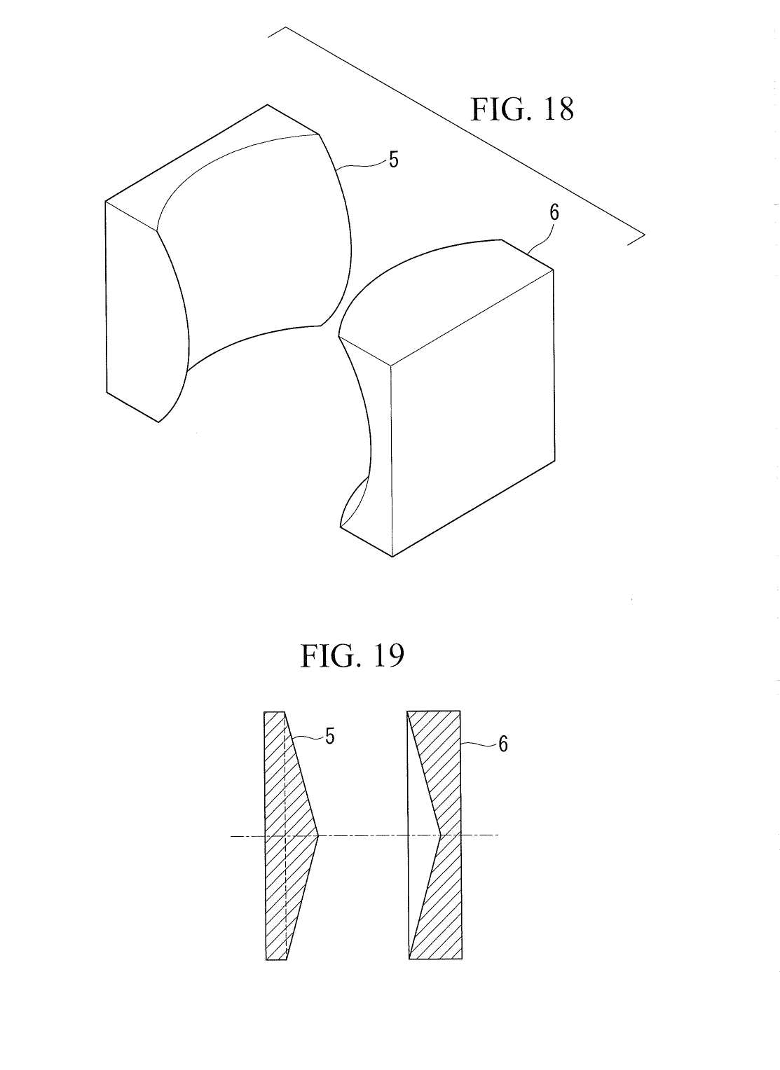

Furthermore, one-dimensional binary diffraction gratings as shown in FIG. 16, one-dimensional sine-wave diffraction gratings as shown in FIG. 17, free curved surface lenses as shown in FIG. 18, cone lenses as shown in FIG. 19, or concentric binary diffraction gratings as shown in FIG. 20 may be employed, instead of a cylindrical lens, for the phase modulation elements 5, 6, 17, and 23 (indicated as the phase modulation elements 5 and 6 in the figure). Concentric diffraction gratings are not limited to the binary type, but any type, including the blazed type and the sine wave type, can be employed.

Diffraction gratings 5 and 6 used as wavefront modulation elements will now be described in detail.

In the intermediate images II in this case, one point image is split into a plurality of point images through diffraction.

Through this operation, the intermediate images II are made unclear, thereby preventing the image of a foreign object on the intermediate-image forming plane from overlapping the final image.

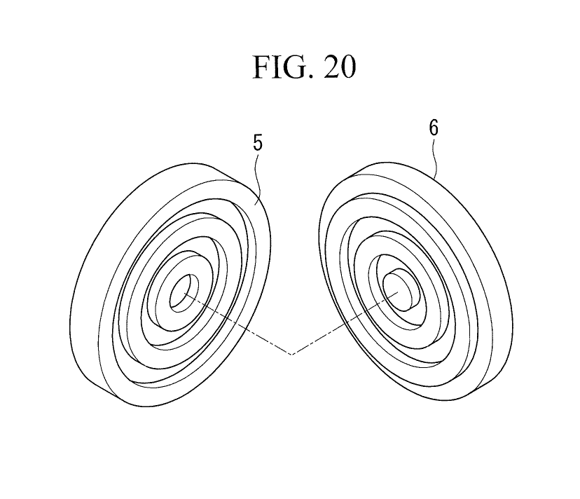

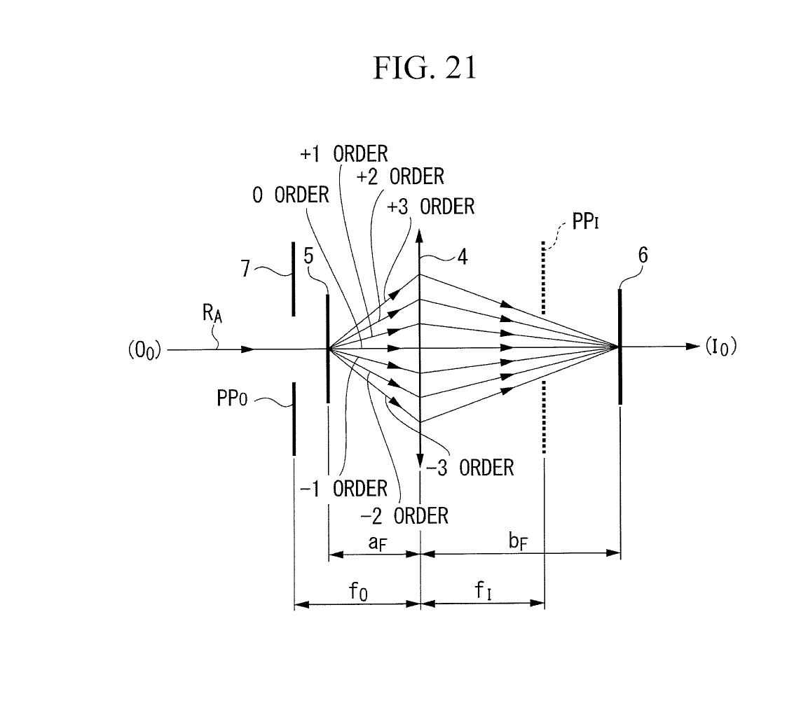

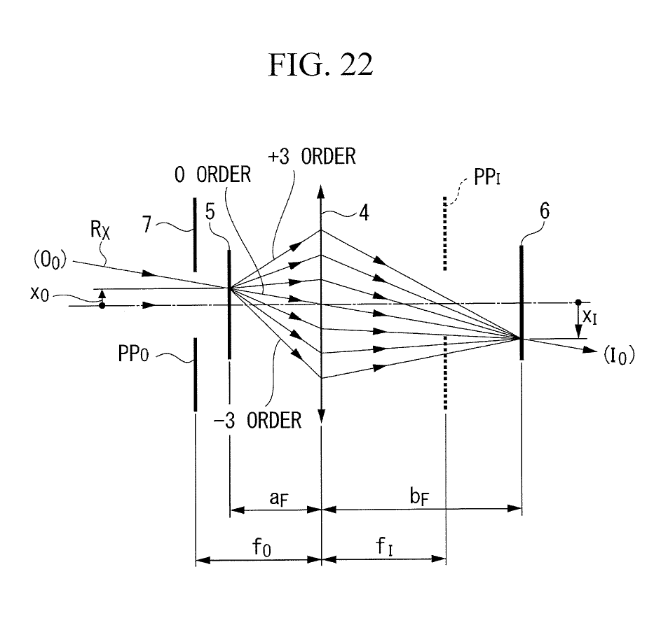

In a case where the diffraction gratings 5 and 6 are used as phase modulation elements, one example of a preferable pathway of the on-axis chief ray, namely, the ray R_{A} along the optical axis is shown in FIG. 21, and one example of a preferable pathway of an on-axis ray R_{X} is shown in FIG. 22. In these figures, each of the rays R_{A} and R_{X} is split into a plurality of diffracted light beams via the diffraction grating 5 and returns to the original one ray via the diffraction grating 6.

Also in this case, the above-described effect can be achieved by satisfying Expressions (1) through (3) above.

Here, in accordance with FIGS. 21 and 22, Expression (2) can be rephrased as “the sum of phase modulation exerted on one on-axis ray R_{X} at the diffraction gratings 5 and 6 is always equal to the sum of phase modulation exerted on the on-axis chief ray R_{A} at the diffraction gratings 5 and 6.”

Furthermore, in a case where the diffraction gratings 5 and 6 have a periodic structure, if their shapes (i.e., phase modulation characteristics) satisfy Expression (2) in an area equivalent to one period, they can also be regarded as satisfying Expression (2) in other areas.

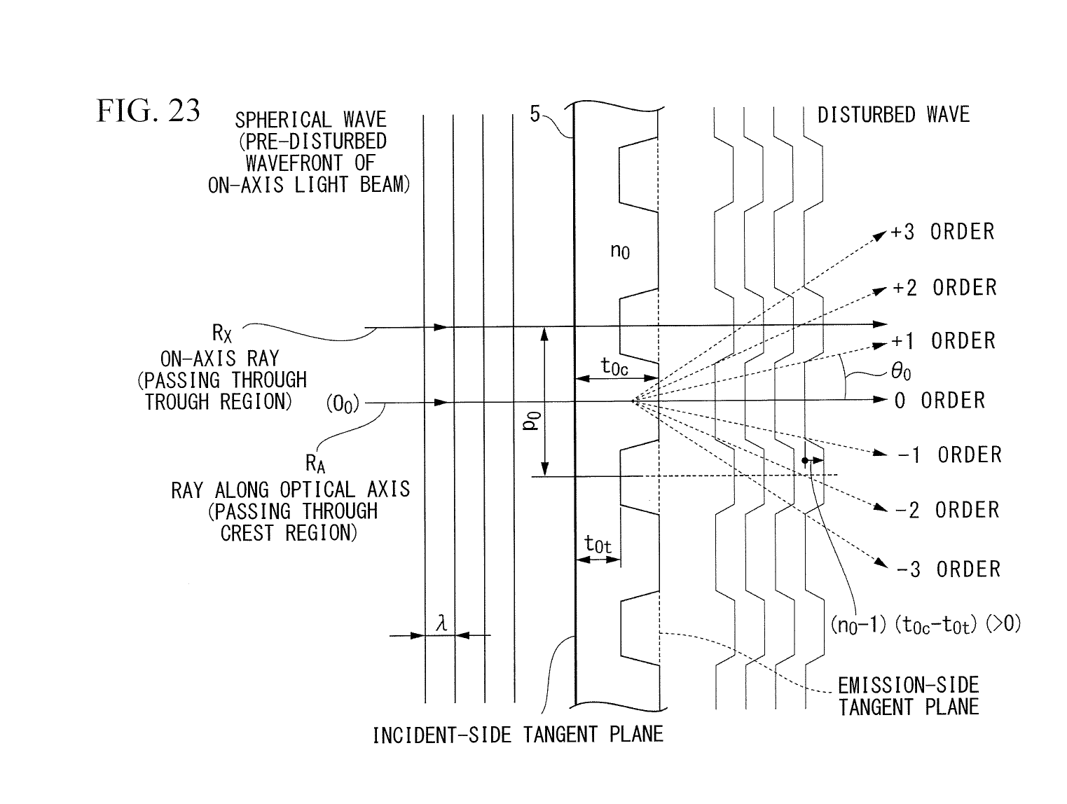

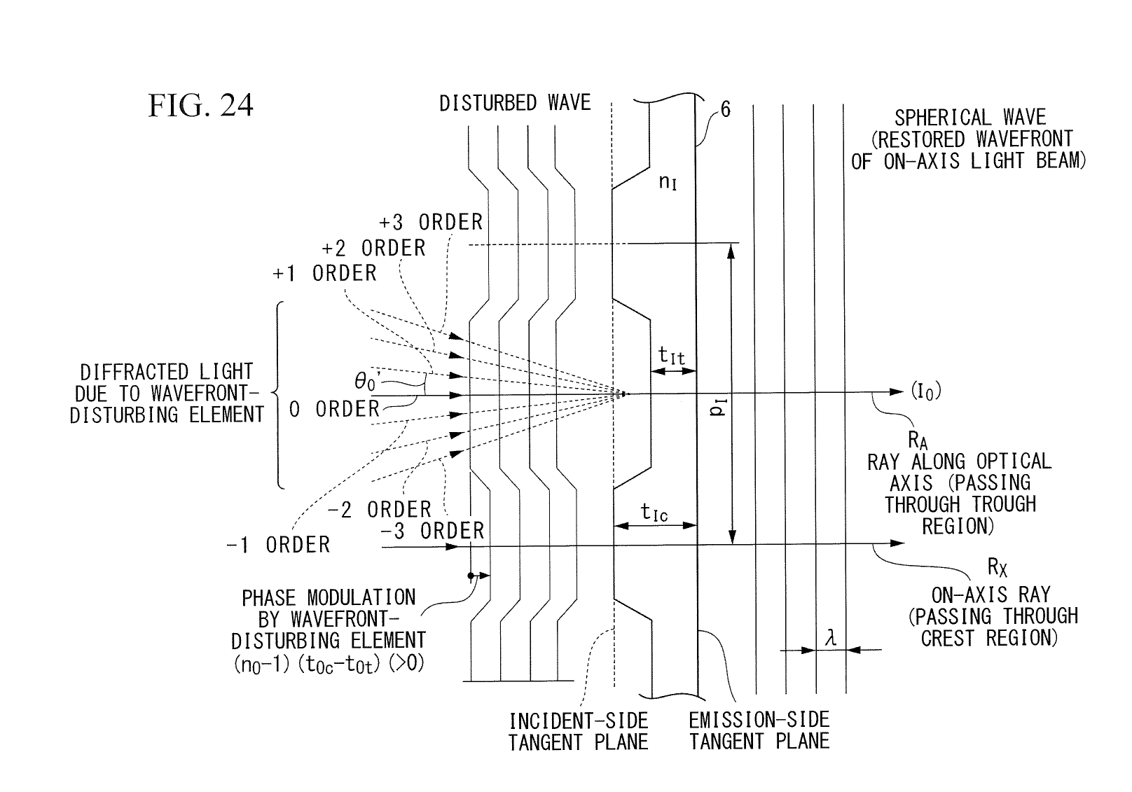

Hence, descriptions will be given with attention focused on the central part, namely, an area in the vicinity of the optical axis of the diffraction gratings 5 and 6. FIGS. 23 and 24 are detailed views of the central parts of the diffraction grating 5 and the diffraction grating 6, respectively.

In this case, conditions required for the diffraction gratings 5 and 6 to satisfy Expression (2) are as follows.

More specifically, the period p_{I} of modulation in the diffraction grating 6 needs to be equal to the period p_{O} of modulation due to the diffraction grating 5 as projected via the field lens 4. In addition, the phase of modulation due to the diffraction grating 6 needs to be reversed to the phase of modulation due to the diffraction grating 5, as projected by the field lens 4, and also, the magnitude of phase modulation due to the diffraction grating 6 needs to be equal to the magnitude of the phase modulation due to the diffraction grating 5 in terms of absolute value.

First, the condition for the period p_{I} and the projected period p_{O} to be equal is represented by Expression (12).

p_{I}=|β_{F}|·p_{O} (12)

Next, in order that the phase of modulation due to the diffraction grating 6 is reversed to the phase of projected modulation due to the diffraction grating 5, not only does the diffraction grating 5 need to be placed, for example, so that one of the centers in its crest regions coincides with the optical axis, but also the diffraction grating 6 needs to be placed so that one of the centers in its trough regions coincides with the optical axis, in addition to the above-described Expression (12) being satisfied. FIGS. 23 and 24 are just one example of them.

Lastly, conditions for the magnitude of phase modulation due to the diffraction grating 6 and the magnitude of phase modulation due to the diffraction grating 5 to be equal in terms of absolute value are examined.

From optical parameters (crest region thickness t_{Oc}, trough region thickness t_{Ot}, and refractive index n_{O}) of the diffraction grating 5, the amount of phase lead ΔL_{Odt} exerted on the on-axis ray R_{X} passing through a trough region of the diffraction grating 5, relative to the ray R_{A} (passing through a crest region) along the optical axis, is represented by Expression (13) below.

ΔL_{Odt}=n_{O}·t_{Oc}−(n_{O}·t_{Ot}+(t_{Oc}−t_{Ot}))=(n_{O}−1)(t_{Oc}−t_{Ot}) (13)

In the same manner, from optical parameters (crest region thickness t_{Ic}, trough region thickness t_{It}, and refractive index n_{I}) of the diffraction grating 6, the amount of phase lead ΔL_{Idt} exerted on the on-axis ray RX passing through a crest region of the diffraction grating 6, relative to the ray R_{A} (passing through a trough region) along the optical axis, is represented by Expression (14) below.

ΔL_{Idt}=(n_{I}·t_{It}+(t_{Ic}·t_{It}))−n_{I}·t_{Ic}=−(n_{I}−1)(t_{Ic}−t_{It}) (14)

In this case, because the value of ΔL_{Odt} is positive and the value of ΔL_{Idt} is negative, conditions for the absolute values of both the values to be equal are represented by Expression (15) below.

ΔL_{Odt}+ΔL_{Idt}=(n_{O}−1)(t_{Oc}−t_{Ot})−(N_{I}−1)(t_{Ic}−t_{It})=0 (15)

Here, although the descriptions have been given on the basis of the on-axis ray, the diffraction grating 5 functions for wavefront disturbance of an off-axis ray, and the diffraction grating 6 functions for wavefront restoration of an off-axis ray, as long as they satisfy the above-described conditions.

Furthermore, although the cross-sectional shape of the diffraction gratings 5 and 6 has been assumed to be a pedestal shape in this example, it is needless to say that other shapes can also exhibit the same function.

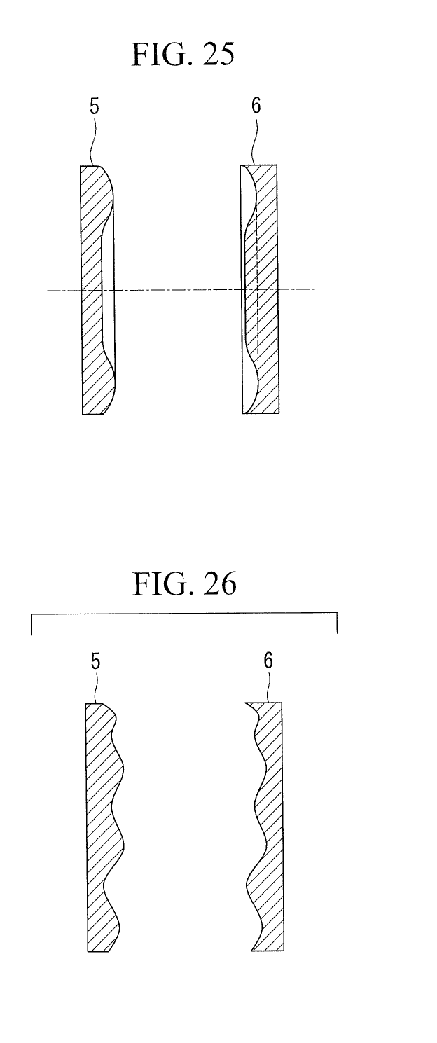

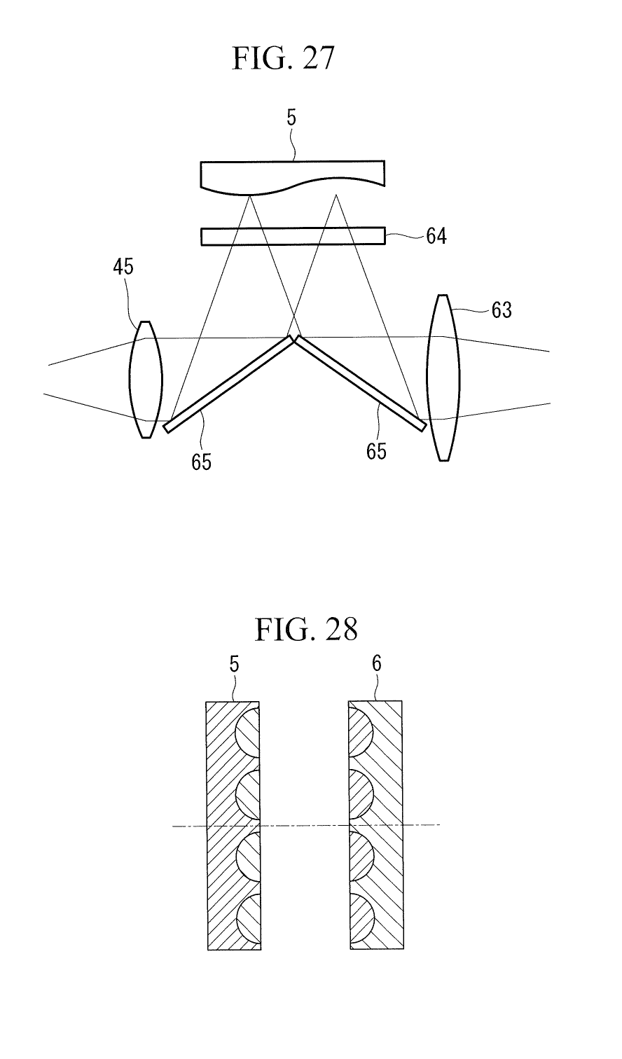

Furthermore, spherical aberration elements as shown in FIG. 25, irregular shape elements as shown in FIG. 26, a reflective wavefront modulation element combined with the transmissive spatial light modulation element 64 as shown in FIG. 27, or gradient index elements as shown in FIG. 28 may be employed as the phase modulation elements 5 and 6.

Furthermore, a fly-eye lens or a micro lens array in which many micro lenses are arranged, or alternatively, a micro prism array in which many micro prisms are arranged may be employed as the phase modulation elements 5 and 6.

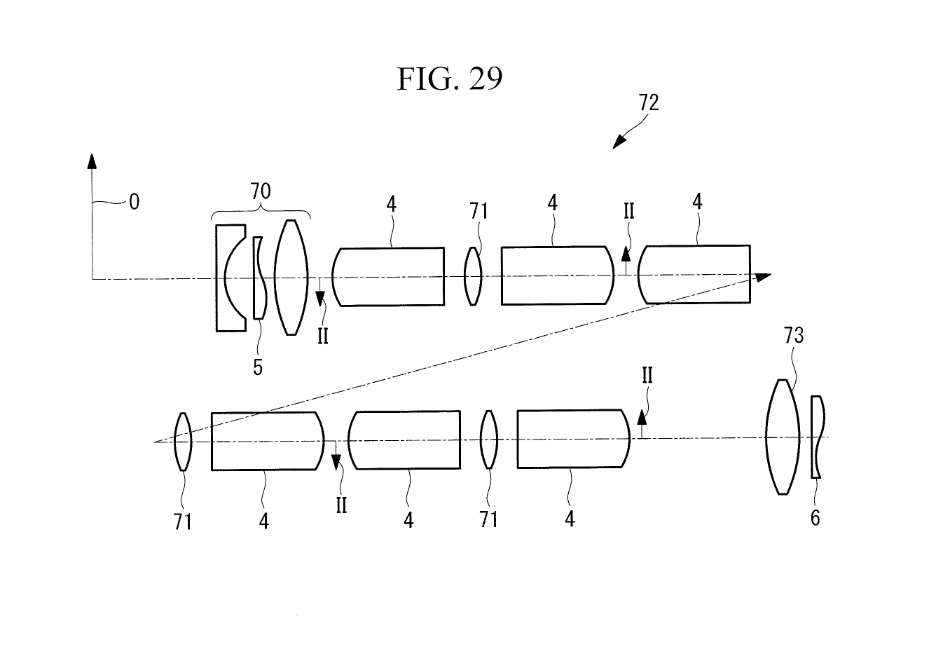

In addition, in a case where the image-forming optical system 1 according to the above-described embodiments is to be applied to an endoscope, it is a good idea to place the wavefront-disturbing element 5 in an objective lens (image-forming lens) 70 and to place the wavefront-restoring element 6 in the vicinity of an eyepiece 73 placed on the opposite side of a relay optical system 72, including the plurality of field lenses 4 and a focusing lens 71, from the objective lens 70, as shown in FIG. 29. By doing so, the intermediate image formed in the vicinity of the surfaces of the field lenses 4 can be made unclear, and the final image formed by the eyepiece 73 can be made clear.

Furthermore, the wavefront-disturbing element 5 may be provided in an endoscopic small-diameter objective lens having an inner focus function 74 for driving the lens 61a with the actuator 62, and the wavefront-restoring element 6 may be placed in the vicinity of the pupil position of a tube lens (image-forming lens) 76 provided in a microscope main body 75, as shown in FIG. 30. As described above, although the actuator itself may be a well-known lens driving means (e.g., a piezoelectric element), an arrangement that allows spatial modulation of intermediate images to be carried out is important in respect of moving the intermediate images in the Z-axis direction, from the same viewpoint as in the above-described embodiment.

### {Modification}

A modification of the image-forming optical system used for the observation apparatus in each of the above-described embodiments will now be described with reference to the drawings.

Although the wavefront-disturbing elements 5, 23 and the wavefront-restoring elements 6, 17 are arranged so as to have a mutually conjugate positional relationship in the above-described embodiments, the wavefront-disturbing elements 5, 23 and the wavefront-restoring elements 6, 17 may be arranged so as to have a non-conjugate positional relationship. In this case, it is desirable that a cylindrical lens be employed as the wavefront-disturbing elements 5, 23 and the wavefront-restoring elements 6, 17.

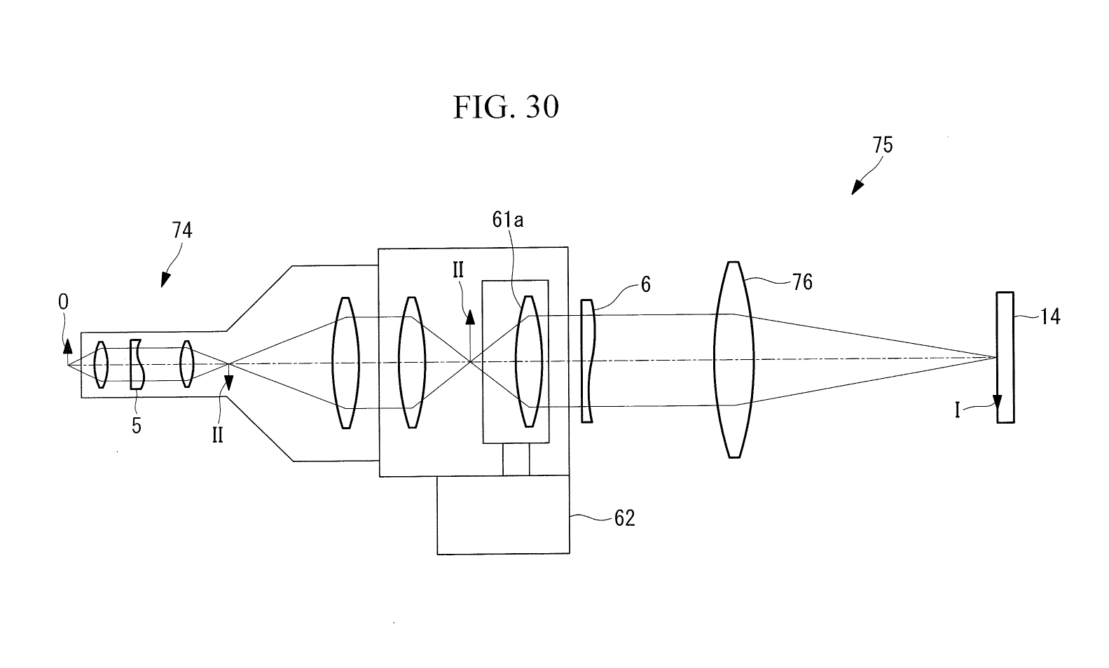

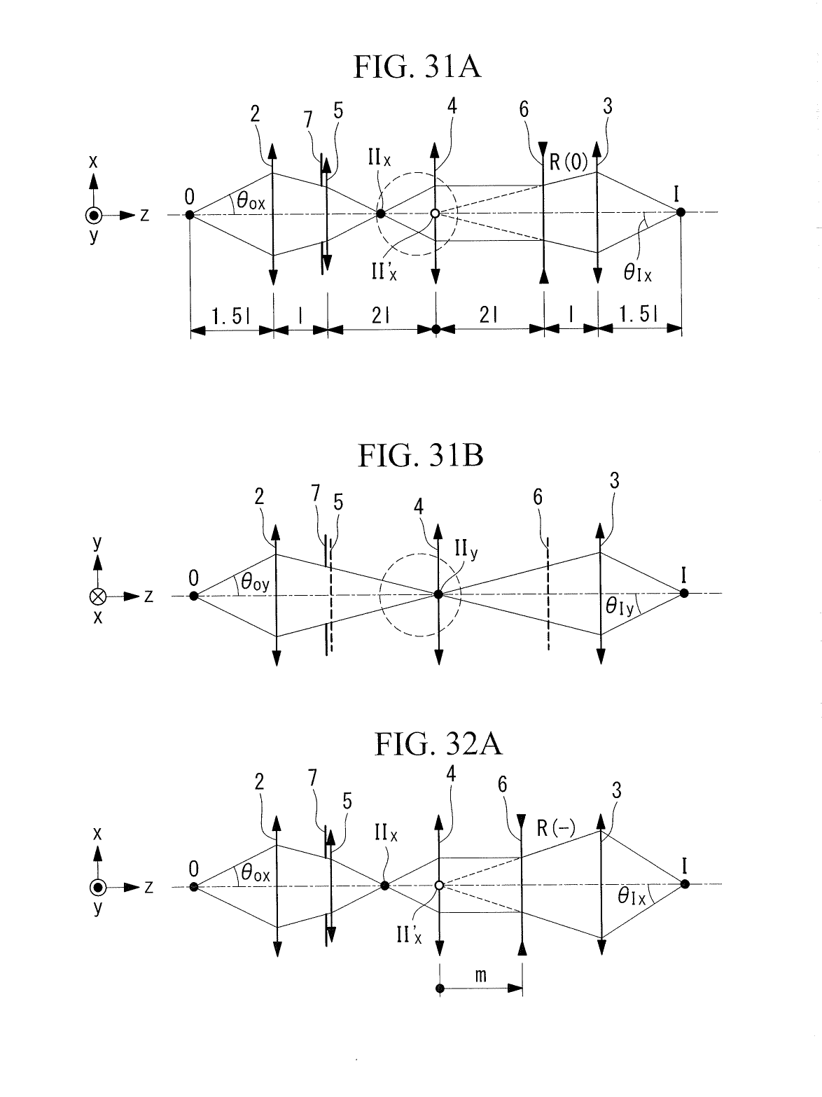

First, referring to FIGS. 31A and 31B, a case where the wavefront-disturbing elements 5, 23 and the wavefront-restoring elements 6, 17 are arranged so as to have a mutually conjugate positional relationship will be described by way of an example of the wavefront-disturbing element 5 and the wavefront-restoring element 6.

In FIGS. 31A and 31B, let the focal length f₀=f_{F}=f_{I}=l, the focal length f_{PMO} of the wavefront-disturbing element 5 f_{PMO}=2l, the focal length f_{PMI} of the wavefront-restoring element 6 f_{PMI}=−2l, Θ_{Ox}=Θ_{Ix}, Θ_{OY}=Θ_{IY}, and β_{X}=β_{Y}=1.

In the example shown in FIGS. 31A and 31B, the image-forming lateral magnifications from the object O to the image point I are equal to 1 for both in the X direction (β_{X}) and in the Y direction (β_{Y}). Furthermore, the pupil-image-forming magnification from the wavefront-disturbing element 5 placed on the pupil plane to the wavefront-restoring element 6 placed on the pupil conjugate plane is equal to −1. An intermediate image II_{X}′ in the X direction, which is a virtual image formed by, for example, a marginal ray R(O) in the form of a ray emitted from the wavefront-restoring element 6, is produced on the field lens 4.

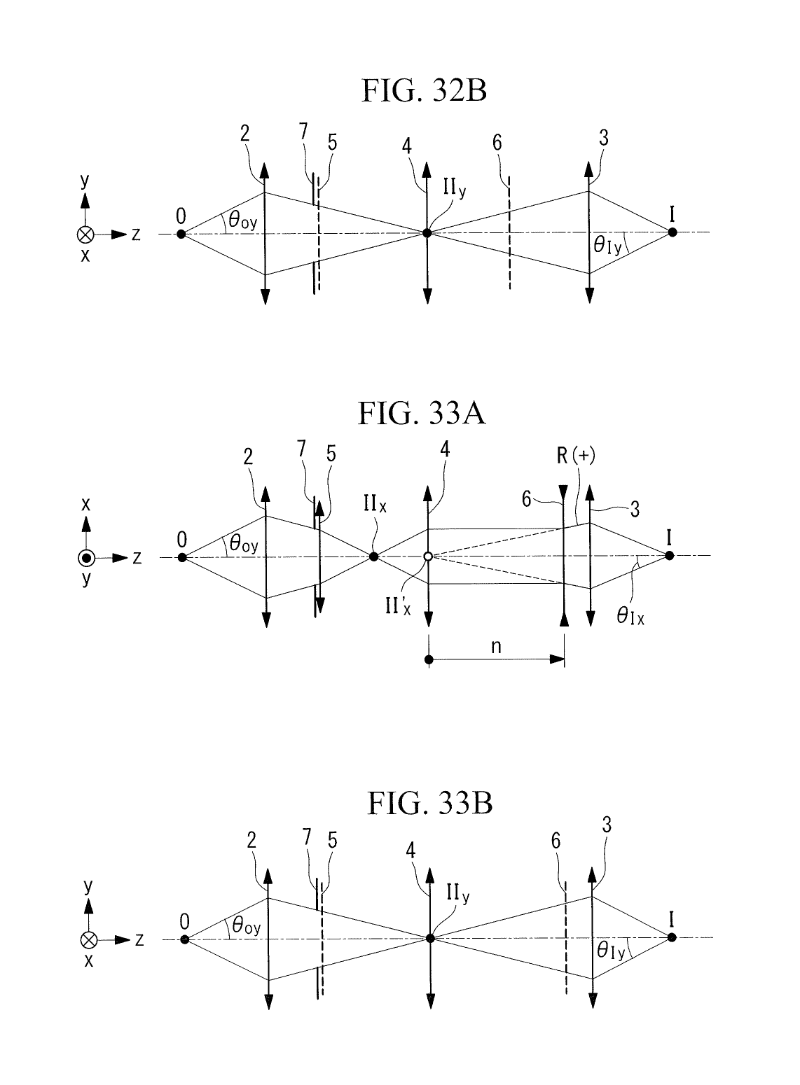

In this embodiment shown in FIGS. 31A and 31B, as well as in the embodiments shown in FIGS. 32A, 32B, 33A, and 33B as described below, the refractive power and arrangement of each of the lenses are chosen so that all light beams emitted from the field lens 4 are collimated light in the X direction. This condition is not essential for configuring these embodiments but just a contrivance for helping understand these embodiments. More specifically, with the help of the above-described conditions in these embodiments, namely, the conditions of the focal length (f_{PMI}) and the arrangement of each of the wavefront-restoring elements 6, as well as the condition that the light beams incident on the wavefront-restoring elements 6 are parallel in the X direction, it will be clearly indicated that, not only in this embodiment shown in FIG. 31A but also in the embodiments shown in FIGS. 32A and 33A described below, the characteristic that the intermediate image II_{X}′ in the X direction, which is a virtual image formed by the light emitted from each of the wavefront-restoring elements 6, is generated on the field lens 4 is provided.

Next, a case where the wavefront-disturbing elements 5, 23 and the wavefront-restoring elements 6, 17 are arranged so as to have a mutually non-conjugate positional relationship will be described by way of an example of the wavefront-disturbing element 5 and the wavefront-restoring element 6. FIGS. 32A and 32B show a case where the wavefront-restoring element 6 is placed closer to the object O side than in a case where the wavefront-disturbing element 5 and the wavefront-restoring element 6 are arranged so as to have a mutually conjugate positional relationship.

In order to form an image I without causing astigmatism with this structure, a marginal ray R(−) in the form of a ray emitted from the wavefront-restoring element 6 needs to diverge more widely than the marginal ray R(O) from the wavefront-restoring element 6 in a case where the wavefront-disturbing element 5 and the wavefront-restoring element 6 are arranged so as to have a mutually conjugate positional relationship. In short, the wavefront-restoring element 6 needs to have more intense negative refractive power as a cylindrical lens. More specifically, the focal length f_{PMI} of the wavefront-restoring element 6 needs to be f_{PMI}=−m, where m(<21) is the distance from the field lens 4 to the wavefront-restoring element 6.

With this structure, the image I is generated without causing astigmatism via the wavefront-restoring element 6. However, when the marginal ray R(−) from the wavefront-restoring element 6 diverges more widely than the marginal ray R(O) in a case where the wavefront-disturbing element 5 and the wavefront-restoring element 6 are arranged so as to have a mutually conjugate positional relationship, the slope Θ_{I} of the marginal ray on the image I side becomes greater than on the object O side only in the X direction (Θ_{Ox}<Θ_{Ix}). This means that a difference is made in the image-forming lateral magnification β between in the X direction and in the Y direction, causing 1× magnification to be maintained (β_{Y}=1) in the Y direction but the image to be reduced in the X direction (β_{X}<1).

Next, FIGS. 33A and 33B show a case where the wavefront-restoring element 6 is placed closer to the image I side than in a case where the wavefront-disturbing element 5 and the wavefront-restoring element 6 are arranged so as to have a mutually conjugate positional relationship. In order to form the image I without causing astigmatism with this structure, a marginal ray R(+) in the form of light emitted from the wavefront-restoring element 6 needs to diverge more narrowly than the marginal ray R(O) in a case where the wavefront-disturbing element 5 and the wavefront-restoring element 6 are arranged so as to have a mutually conjugate positional relationship. In short, the wavefront-restoring element 6 needs to have weaker negative refractive power as a cylindrical lens. More specifically, the focal length f_{PMI} of the wavefront-restoring element 6 needs to be f_{PMI}=−n, where n(n>21) is the distance from the field lens 4 to the wavefront-restoring element 6. By doing so, the intermediate image II_{X}′ formed by the marginal ray R(+) can be generated on the field lens 4.

With this structure, the image I is generated without causing astigmatism via the wavefront-restoring element 6. However, when the marginal ray R(+) from the wavefront-restoring element 6 diverges more narrowly than the marginal ray R(O) in a case where the wavefront-disturbing element 5 and the wavefront-restoring element 6 are arranged so as to have a mutually conjugate positional relationship, the slope Θ_{I} of the marginal ray on the image I side becomes smaller than on the object O side only in the X direction (Θ_{Ox}>Θ_{Ix}). This means that a difference is made in the image-forming lateral magnification β between in the X direction and in the Y direction, causing 1× magnification to be maintained (β_{Y}=1) in the Y direction but the image to be increased in the X direction (β_{X}>1).

As described above, even if the wavefront-disturbing element 5 and the wavefront-restoring element 6 are not arranged so as to have a conjugate positional relationship, the image I can be formed without causing astigmatism by properly selecting the refractive power of the cylindrical lenses, serving as the wavefront-disturbing element 5 and the wavefront-restoring element 6. In short, the wavefront disturbance caused by the wavefront-disturbing element 5 can be cancelled out by the wavefront-restoring element 6.

In this case, however, a difference is made between the image-forming magnification in the X direction and the image-forming magnification in the Y direction. To overcome this problem, it is desirable that means for eliminating the difference in image-forming magnification between in the X direction and in the Y direction be employed. By doing so, even in a case where the wavefront-disturbing element 5 and the wavefront-restoring element 6 are not arranged so as to have a conjugate positional relationship, the magnifications of the ultimately observed image both in the X direction and in the Y direction can be made identical while still forming an image without causing astigmatism. Any method capable of converting so-called the aspect ratio of an image is acceptable as means for eliminating the difference in image-forming magnification between in the X direction and in the Y direction.

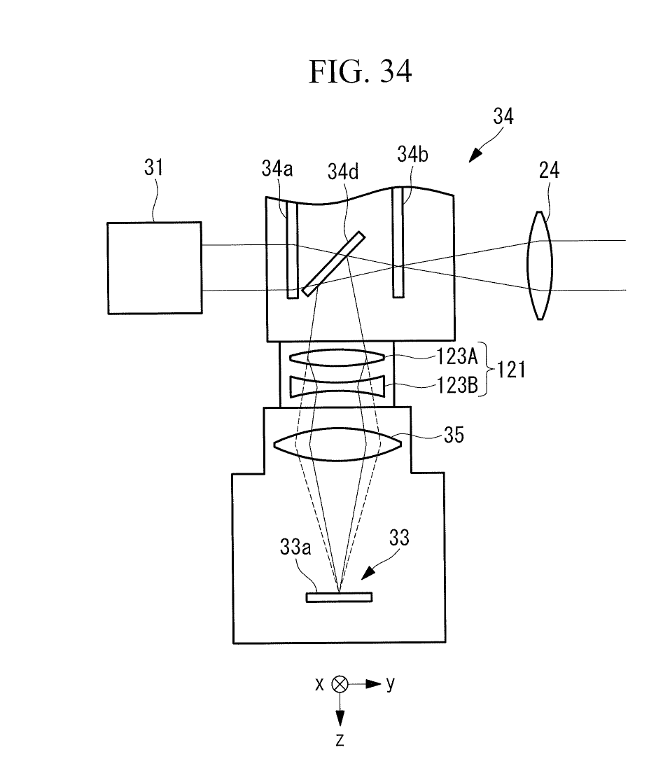

As means for optically eliminating the difference in image-forming magnification between in the X direction and in the Y direction, an aspect-ratio conversion optical system 121 composed of cylindrical lenses or toroidal lenses may be employed as shown in, for example, FIG. 34. In the example shown in FIG. 34, the aspect-ratio conversion optical system 121 includes a convex-shaped cylindrical lens 123A and a concave-shaped cylindrical lens 123B and is placed, for example, before the image-capturing element 33 (refer to FIG. 6).

In the aspect-ratio conversion optical system 121, the magnification in the X direction is constant and the magnification in the Y direction is increased, and the focal positions coincide in the X direction and in the Y direction. In short, the aspect-ratio conversion optical system 121 is configured so as to exhibit different magnifications between in the X direction and in the Y direction but to have the same focal position both in the X and Y directions. From among the rays coming from the aspect-ratio conversion optical system 121 and incident on the image-capturing element 33 in FIG. 34, the solid lines indicate a ray in the Y direction, and broken lines indicate a ray in the X direction.

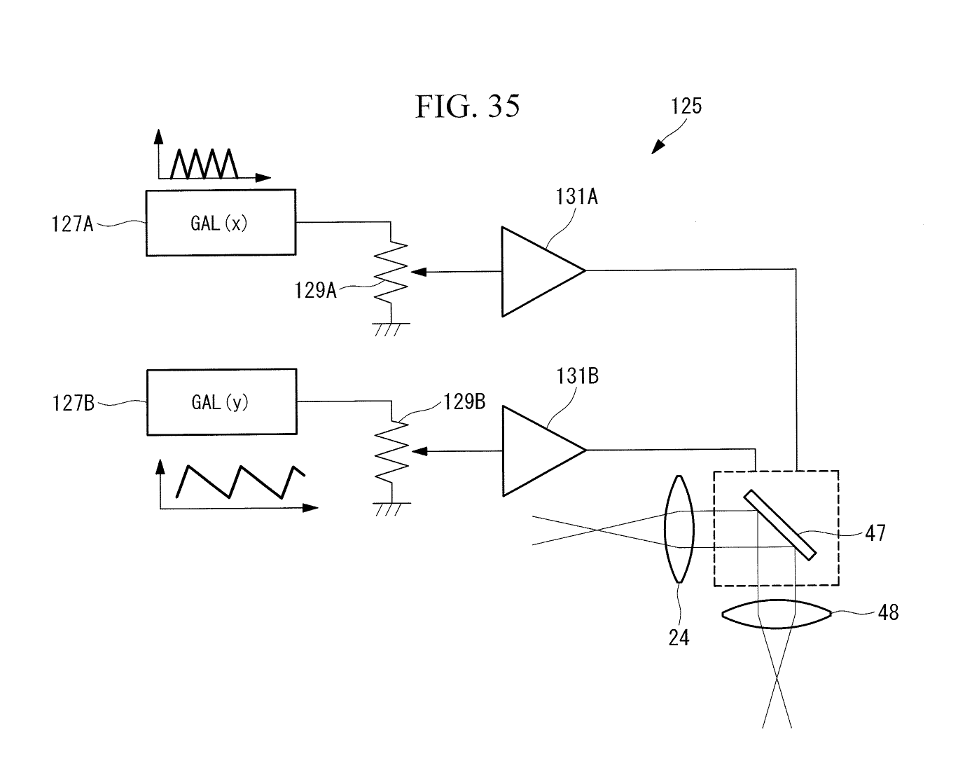

Next, as shown in, for example, FIG. 35, in a case where an optical system is combined with a sampling function for X-direction and Y-direction scanning by the use of the galvanometer mirror 47 (refer to FIG. 7), an aspect-ratio conversion mechanism 125 capable of converting the image aspect ratio by changing the ratio between the scan widths in the X scanning and in the Y scanning for a predetermined number of samplings may be employed as means for mechanically eliminating a difference in image-forming magnification.

The aspect-ratio conversion mechanism 125 includes a signal source 127A in the X direction, a signal source 127B in the Y direction, variable resistors 129A and 129B, and drive amplifiers 131A and 131B. Each of the signal source 127A in the X direction and the signal source 127B in the Y direction outputs a sawtooth signal. By relatively adjusting, through the variable resistors 129A and 129B, the voltages of the signals from the signal source 127A in the X direction and the signal source 127B in the Y direction before they are input to the drive amplifiers 131A and 131B, each of the swing width in the X direction and the swing width in the Y direction of the galvanometer mirror 47 can be changed.

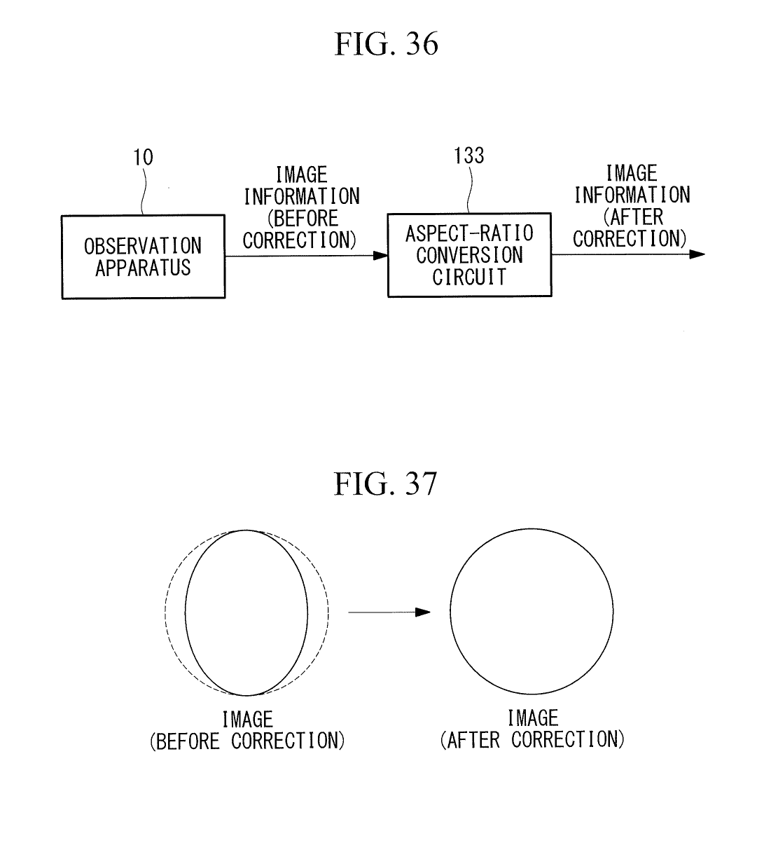

Subsequently, as shown in, for example, FIG. 36, an aspect-ratio conversion circuit 133 or an aspect-ratio conversion program capable of converting the aspect ratio of an image by applying aspect-ratio correction processing to the image information acquired by the observation apparatus 10 (refer to FIG. 5) may be employed as means for electrically eliminating a difference in image-forming magnification. If the examination object A is, for example, circular as shown in FIG. 37, an image acquired in an elliptical shape can be corrected into an image of a circular shape with the aspect-ratio conversion circuit 133.

The aforementioned characteristics that have been described by way of an example in which the wavefront-disturbing element 5 and the wavefront-restoring element 6, which constitute a pair of the phase modulation element and the phase-demodulation element composed of cylindrical lenses, are arranged so as to have an optically non-conjugate positional relationship are not limited to the structures in FIGS. 32A and 32B or FIGS. 33A and 33B. Rather, these characteristics are common to all structures derived from the above descriptions, including structures where the basic arrangement forms so-called the 4f optical system, as well as structures where lenses having any refractive power and cylindrical lenses having any refractive power are combined.

The wavefront-disturbing element 5 and the wavefront-restoring element 6 according to this modification can be applied to the observation apparatuses 10, 30, 40, 50, and 60, serving as microscopes in the above-described embodiments. Furthermore, the wavefront-disturbing element 5 and the wavefront-restoring element 6 according to this modification may be combined with other various types of microscopes.

It is needless to say that each of the above-described embodiments in which the wavefront-disturbing element 5 and the wavefront-restoring element 6 are arranged so as to have a mutually conjugate positional relationship not only can be applied to the observation apparatuses 10, 30, 40, 50, and 60 serving as microscopes, as described above, but also can be combined with other various types of microscopes.

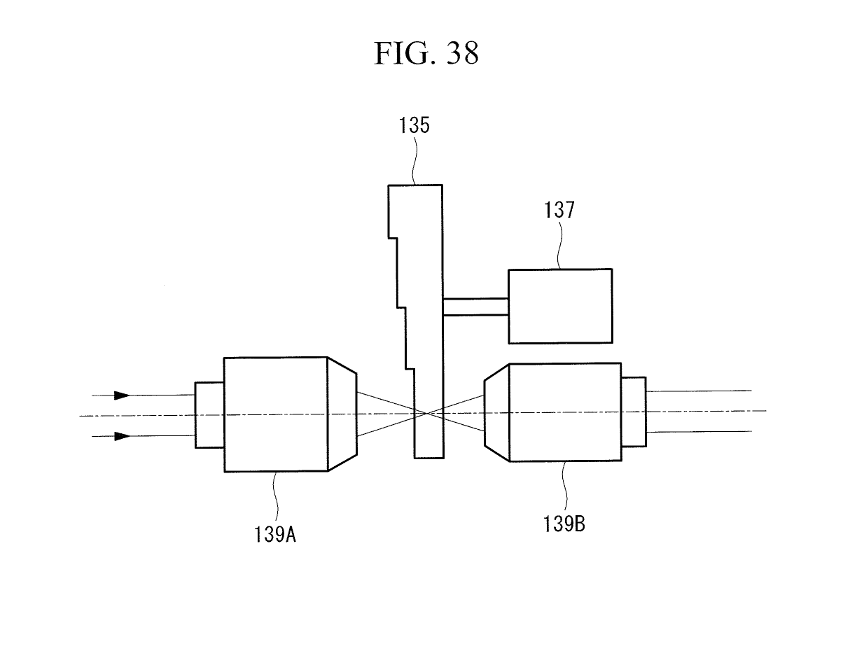

For example, the embodiments may be combined with an optical system that is provided with a parallel plate 135 and that changes the focal position by employing a method for switching the thickness of the parallel plate 135, as shown in FIG. 38. In that case, the optical system in FIG. 38 may be combined with the observation apparatuses 10, 30, 40, 50, and 60, serving as microscopes, in which the wavefront-disturbing element 5 and the wavefront-restoring element 6 may be arranged in a conjugate or non-conjugate manner to each other. The parallel plate 135 is formed of glass members having a stepped shape and having different thicknesses and is placed in the vicinity of the focal position of lenses 139A and 139B facing each other.

This parallel plate 135, as a result of being rotated about the axis line by a motor 137, can change the thickness of the parallel plate 135 placed in the vicinity of the focal position of the lenses 139A and 139B. The optical-path length can be changed at high speed by changing, with the motor 137, the thickness of the parallel plate 135 placed at the focal position of the lenses 139A and 139B.

Alternatively, the embodiments may be combined with the multispot scanning (line scanning) microscopes described in Japanese Unexamined Patent Application, Publication No. H10-282010 and Japanese Unexamined Patent Application, Publication No. 2006-53542. In that case, the illuminating device, the X-axis scanning apparatus, and the observation light detection apparatus in the above-described line scanning microscopes may be replaced with the Nipkow disk confocal optical system 34 in the above-described observation apparatus 30 or may be replaced with the laser light source 41, the image-forming optical system 42, the confocal pinhole 43, and the photodetector 44 in the above-described observation apparatus 40, thus configuring an observation apparatus, and in this observation apparatus, the wavefront-disturbing element 5 and the wavefront-restoring element 6 may be arranged in a conjugate or non-conjugate manner to each other.

Furthermore, the embodiments may be combined with a microscope employing a disk with a slit pattern as described in Publication of Japanese Patent No. 4334801 or may be combined with a super-resolution microscope employing a disk with a slit pattern as described in Non-Patent Literature “Ultrafast superresolution fluorescent imaging with spinning disk confocal microscope optics”, Molecular Biology of the Cell, vol. 26, p. 1743-1751, May 1, 2015. In that case, the illuminating device, the rotational scanning apparatus, and the observation light detection apparatus in the above-described microscope employing a disk with a slit pattern may be replaced with the Nipkow disk confocal optical system 34 in the above-described observation apparatus 30, thus configuring an observation apparatus, and in this observation apparatus, the wavefront-disturbing element 5 and the wavefront-restoring element 6 may be arranged in a conjugate or non-conjugate manner to each other.

Alternatively, the embodiments may be combined with a STED (Stimulated Emission Depletion) microscope as described in Non-Patent Literature “Breaking the diffraction resolution limit by stimulated emission: stimulated-emission-depletion fluorescence microscopy” Optics Letters, Vol. 19, p. 780-782, 1994. In that case, the illuminating device in the above-described STED microscope may be replaced with the laser light source 41 in the above-described observation apparatuses 40, 50, and 60, thus configuring an observation apparatus, and in this observation apparatus, the wavefront-disturbing element 5 and the wavefront-restoring element 6 may be arranged in a conjugate or non-conjugate manner to each other.

In the above-described embodiments, a method for applying the process of making an intermediate image unclear through phase modulation to an image-forming optical system of an observation apparatus has been discussed from the viewpoint of moving the intermediate image and the final image in the Z-axis direction. Movement of an intermediate image and a final image in XY-axis directions (or on the image plane), which serves as another viewpoint of an image-forming optical system, will be discussed below. Thus, the present invention covers not only light scanning in the Z-axis direction but also light scanning in the XY-axis directions. Furthermore, the present invention can be applied to three-dimensional observation in which movements of an intermediate image and a final image both in the Z-axis direction and XY-axis directions are combined. In the following aspects, movement of an intermediate image and a final image in the XY-axis directions will be described in detail. In the following description, in order to discriminate from shifting means only for moving the intermediate image in the Z-axis direction, the shifting means only for moving the intermediate image and the final image in the XY-axis directions is referred to as a scanner.

One aspect of the present invention provides an observation apparatus including: an image-forming optical system provided with a plurality of image-forming lenses for forming a final image and at least one intermediate image, a first phase modulation element that is placed towards an object from one of the intermediate images formed by the image-forming lenses and that imparts a spatial disturbance to the wavefront of the light from the object, and a second phase modulation element that is placed at a position, between that position and the first phase modulation element being at least one intermediate image, and that cancels out the spatial disturbance imparted by the first phase modulation element to the wavefront of the light from the object; a light source that is placed on the object side of the image-forming optical system and that generates illumination light entering the image-forming optical system; a first scanner and a second scanner that are placed in the optical axis direction with a space therebetween and that scan the illumination light from the light source; and a photodetector for detecting light emitted from an examination object placed at the final image position of the image-forming optical system, wherein the first phase modulation element and the second phase modulation element are placed at optically conjugate positions to the first scanner placed on the light source side and have one-dimensional phase distribution characteristics that change in a direction coinciding with the illumination-light scanning direction by the first scanner.

According to this aspect, when the illumination light emitted from the light source enters from the object side of the image-forming lenses, it is focused by the image-forming lenses, thereby forming a final image. In this process, through the first phase modulation element placed towards the object from one of the intermediate images, a spatial disturbance is imparted to the wavefront of the illumination light, thus blurring and making unclear the formed intermediate image. In addition, when the illumination light that has formed the intermediate image passes through the second phase modulation element, the spatial disturbance imparted to the wavefront by the first phase modulation element is cancelled out. Because of this, a clear image can be obtained in the formation of the final image that is carried out in the subsequent sections.

In other words, as a result of the intermediate image being blurred and made unclear, even if the intermediate-image is placed in the vicinity of an optical element on the surface or in the interior of which a flaw, foreign object, defect, and so forth are present, it is possible to prevent the occurrence of a disadvantage in that the flaw, foreign object, defect, and so forth overlap the intermediate image, eventually forming a part of the final image.

Furthermore, because the illumination light from the light source is scanned two-dimensionally by the first scanner and the second scanner, it is possible to two-dimensionally scan the final image formed on the examination object. In this case, although the beam of the illumination light moves in a one-dimensional linear direction when the first scanner is actuated, the position of the light beam as passing through the second phase modulation element does not vary because the first scanner and the second phase modulation element are arranged at optically conjugate positions.

On the other hand, the second scanner spaced apart from the first scanner in the optical axis direction is not placed so as to have an optically conjugate positional relationship with the second phase modulation element, and therefore, the beam of the illumination light moves so as to change the travel position in the second phase modulation element when the second scanner is actuated. The direction in which the phase distribution characteristics of the second phase modulation element change coincides with the illumination-light scanning direction by the first scanner, and the phase distribution characteristics do not change in an orthogonal direction, namely, in the illumination scanning direction by the second scanner. Therefore, the phase modulation imparted to the illumination light does not change even if the travel position of the beam of illumination light changes.

Therefore, according to this aspect, whichever of the first scanner and the second scanner arranged with a space therebetween in the optical axis direction is operated, the phase modulation due to the second phase modulation element is not changed and can be maintained constant without being affected by the scanning state of illumination light, thus making it possible to completely cancel out the spatial disturbance on the wavefront imparted by the first phase modulation element.

In the above-described aspect, the above-described first phase modulation element and the above-described second phase modulation element may be a lenticular element. Furthermore, in the above-described aspect, the above-described first phase modulation element and the above-described second phase modulation element may be a prism array. In addition, in the above-described aspect, the above-described first phase modulation element and the above-described second phase modulation element may be a diffraction grating. Alternatively, in the above-described aspect, the above-described first phase modulation element and the above-described second phase modulation element may be a cylindrical lens.

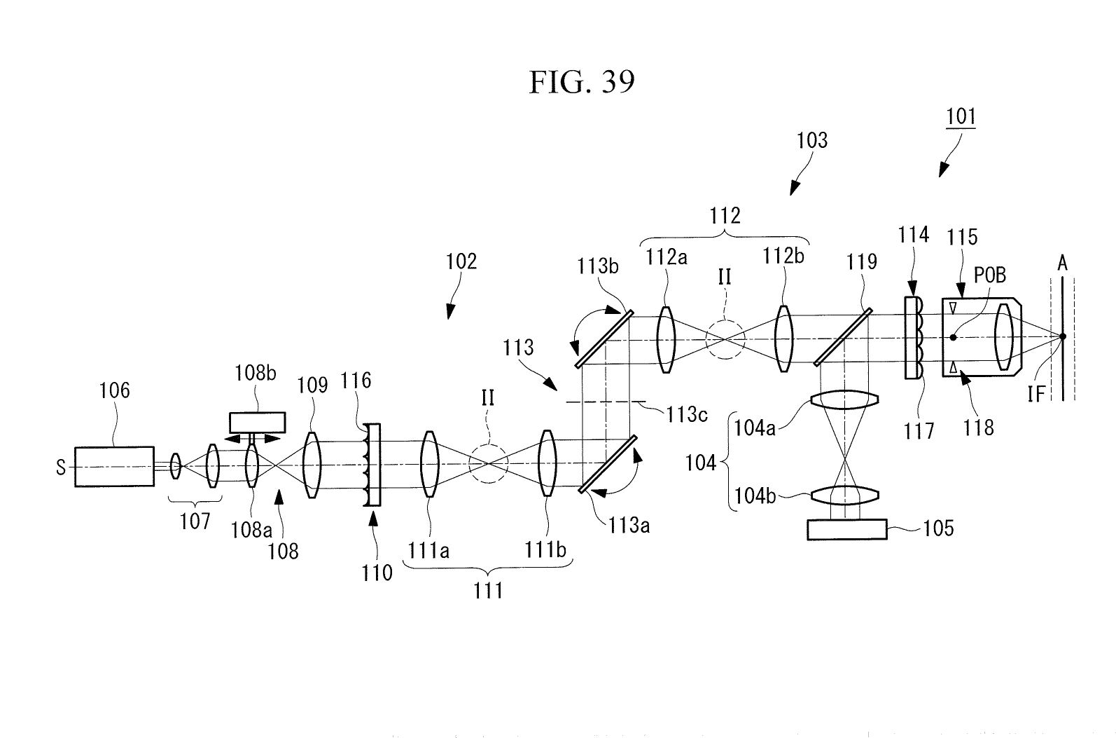

An observation apparatus 101 according to one embodiment of the present invention will be described below with reference to the drawings. The observation apparatus 101 according to this embodiment is, for example, a multiphoton-excitation microscope. As shown in FIG. 39, the observation apparatus 101 includes: an illuminating device 102 for irradiating an examination object A with an ultra-short pulsed laser beam (hereinafter, referred to simply as a laser beam (illumination light)); a detector optical system 104 for guiding, to a photodetector 105, the fluorescence generated in the examination object A as a result of the laser beam being radiated from the illuminating device 102; and the photodetector 105 for detecting the fluorescence guided by the detector optical system 104.

The illuminating device 102 includes: a light source 106 for generating a laser beam; and an image-forming optical system 103 for irradiating the examination object A with the laser beam from the light source 106. The image-forming optical system 103 includes: a beam expander 107 for magnifying the beam diameter of a laser beam from the light source 106; a Z scanning section 108 that forms an intermediate image by focusing the laser beam having passed through the beam expander 107 and that moves the image-forming position in a direction along the optical axis S; and a collimating lens 109 for converting, into substantially collimated light, the laser beam having passed through the Z scanning section 108 and formed the intermediate image.

The image-forming optical system 103 further includes: a wavefront-disturbing element (first phase modulation element) 110 placed at a position through which the laser beam converted into substantially collimated light by the collimating lens 109 passes; a plurality of pairs of relay lenses (image-forming lenses) 111 and 112 for relaying the intermediate image formed by the Z scanning section 108; an XY-scanning section 113 that is placed between the pairs of relay lenses 111 and 112 and that is composed of a galvanometer mirror (first scanner) 113a on the light source 106 side and a galvanometer mirror (second scanner) 113b on the examination object A side; a wavefront-restoring element (second phase modulation element) 114 placed at a position through which the laser beam converted into substantially collimated light via the pairs of relay lenses 111 and 112 passes; and an objective lens (image-forming lens) 115 that irradiates the examination object A by focusing the laser beam having passed through the wavefront-restoring element 114 and that collects the fluorescence generated at the focusing point (final image IF) of the laser beam in the examination object A.

The Z scanning section 108 includes: a focusing lens 108a for focusing the laser beam whose beam diameter has been magnified by the beam expander 107; and an actuator 108b for moving the focusing lens 108a in a direction along the optical axis S. The image-forming position can be moved in a direction along the optical axis S by moving the focusing lens 108a in a direction along the optical axis S by the use of the actuator 108b.

The wavefront-disturbing element 110 is a lenticular element composed of an optically transparent material that can transmit light. When transmitting a laser beam, the wavefront-disturbing element 110 imparts to the wavefront of the laser beam a phase modulation that changes in a one-dimensional direction orthogonal to the optical axis S according to the shape of a surface 116. In this embodiment, it imparts a necessary wavefront disturbance by transmitting once a laser beam from the light source 106.

The pair of relay lenses 111 form an intermediate image II by focusing, with one lens 111a, the laser beam converted into substantially collimated light by the collimating lens 109 and thereafter return substantially collimated light by focusing again the spreading laser beam with the other lens 111b. In this embodiment, the two pairs of relay lenses 111 and 112 are arranged with a space therebetween so as to sandwich the XY-scanning section 113 in a direction along the optical axis S.

The galvanometer mirrors 113a and 113b are provided so as to be capable of swinging about axes that are orthogonal to the optical axis S and that are arranged at twisted positions. As a result of being swung, these galvanometer mirrors 113a and 113b can change the slope angle of the laser beam in a two-dimensional direction orthogonal to the optical axis S and scan the position of the final image I_{F} due to the objective lens 115 in a two-dimensional direction intersecting the optical axis S.

The wavefront-restoring element 114 is a lenticular element that is composed of an optically transparent material that can transmit light and that has opposite phase distribution characteristics from those of the wavefront-disturbing element 110. When transmitting a laser beam, the wavefront-restoring element 114 imparts to the wavefront of the light a phase modulation that changes only in a one-dimensional direction orthogonal to the optical axis S according to the shape of a surface 117 and cancels out the wavefront disturbance imparted by the wavefront-disturbing element 110.

In this embodiment, the two galvanometer mirrors 113a and 113b are arranged with a space therebetween in a direction along the optical axis S and are arranged so that their halfway position 113c is a position that is substantially optically conjugate to the pupil position POB of the objective lens 115.

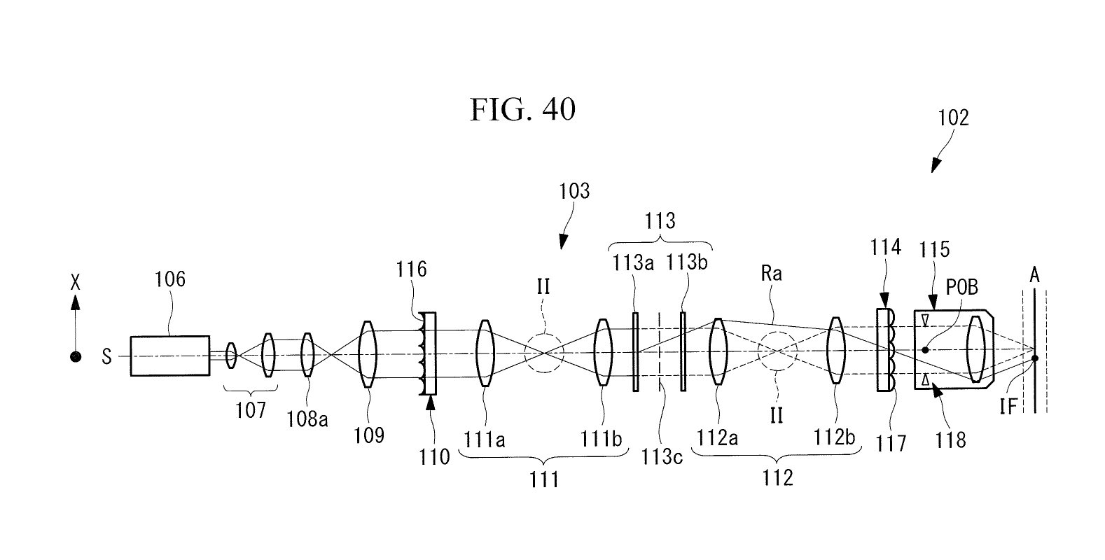

Furthermore, the galvanometer mirror 113a on the light source 106 side is placed at an optically conjugate position to the wavefront-disturbing element 110 and the wavefront-restoring element 114. By doing so, even if the galvanometer mirror 113a on the light source 106 side is swung and a slope angle is imparted to the laser beam, a center ray Ra of a light beam P of the laser beam intersects the optical axis S on the surface 117 of the wavefront-restoring element 114, as shown in FIG. 40. In other words, the light beam P of the laser beam can pass through the same area without changing the travel position in the wavefront-restoring element 114.

Then, this galvanometer mirror 113a is placed such that the swing direction thereof (direction indicated by arrow X in FIG. 40) coincides with the direction in which the phase distribution characteristics of the wavefront-restoring element 114 change.

As described above, because the light beam P of the laser beam passes through the same area of the wavefront-restoring element 114 regardless of the galvanometer mirror 113a being swung, it is not necessary to change the phase modulation to be imparted to the laser beam even if the galvanometer mirror 113a is swung.

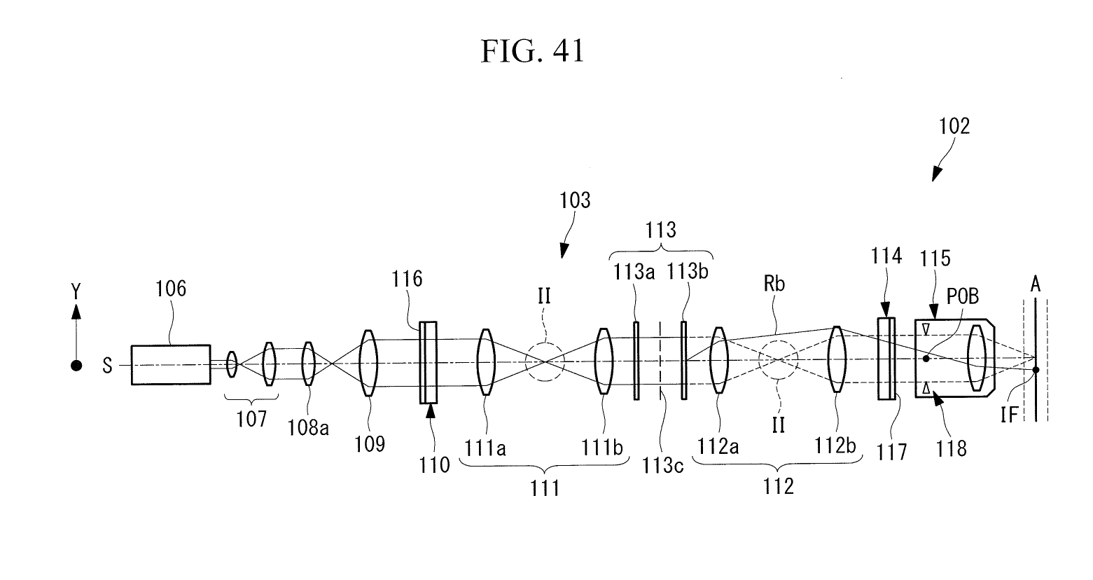

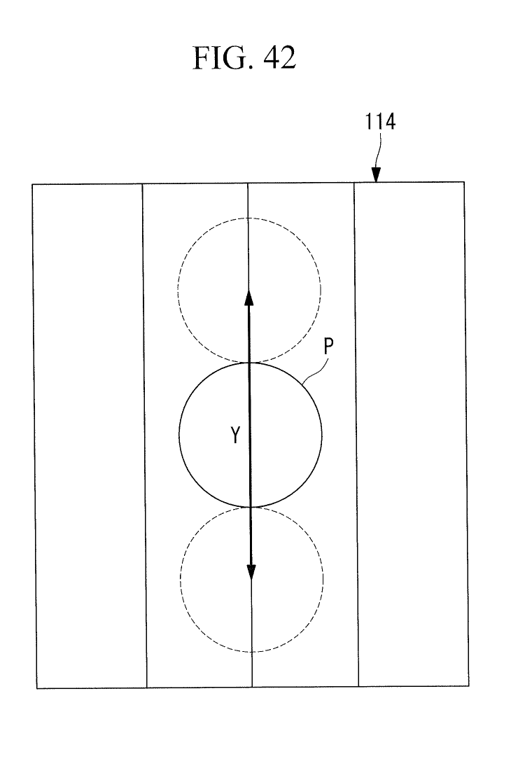

On the other hand, the galvanometer mirror 113b on the examination object A side is placed at an optically non-conjugate position to the wavefront-restoring element 114. By doing so, when the galvanometer mirror 113b on the examination object A side is swung and a slope is imparted to the laser beam, a center ray Rb of light beam P of the laser beam is apart from the optical axis S on the surface of the wavefront-restoring element 114, as shown in FIG. 41. This galvanometer mirror 113b is placed such that the swing direction thereof (the direction indicated by arrow Y in FIG. 41) coincides with a direction (direction in which the phase distribution characteristics of the wavefront-restoring element 114 do not change) orthogonal to the direction in which the phase distribution characteristics change. Because of this, when the galvanometer mirror 113b on the examination object A side is swung and a slope corresponding to this swinging is imparted to the laser beam from the galvanometer mirror 113a on the light source 106 side, this slope imparted to the laser beam causes the travel position of the light beam P of the laser beam in the wavefront-restoring element 114 to move in a direction in which the phase distribution characteristics of the wavefront-restoring element 114 do not change, as shown in FIG. 42.

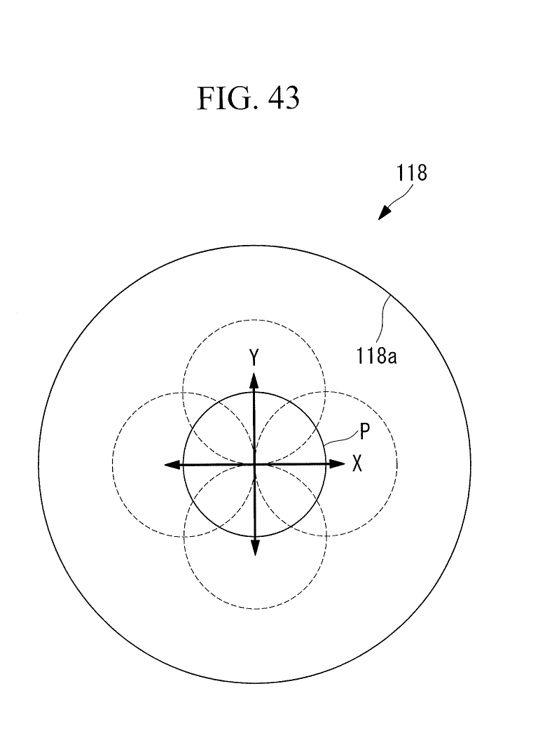

As described above, both the galvanometer mirrors 113a and 113b are arranged at non-conjugate positions to the pupil position POB of the objective lens 115, and, as a result of the galvanometer mirrors 113a and 113b being swung, the light beam P of the laser beam moves in two-dimensional directions indicated by arrows X and Y at the pupil position POB of the objective lens 115, as shown in FIG. 43. However, its movement range is limited to a small area through which the light beam P can pass without being blocked by an opening 118a of an aperture stop 118 placed at the pupil position POB of the objective lens 115.

The detector optical system 104 includes: a dichroic mirror 119 for splitting off the fluorescence collected by the objective lens 115 from the optical path of the laser beam; and two focusing lenses 104a and 104b for focusing the fluorescence split off by the dichroic mirror 119. The photodetector 105 is, for example, a photomultiplier tube and detects the intensity of the incident fluorescence.

The operation of the observation apparatus 101 according to this embodiment with this structure will be described below. In order to observe the examination object A by the use of the observation apparatus 101 according to this embodiment, the image-forming optical system 103 irradiates the examination object A with a laser beam emitted from the light source 106. First, the beam diameter is magnified by the beam expander 107, and then the laser beam passes through the Z scanning section 108, the collimating lens 109, and the wavefront-disturbing element 110.

The laser beam is focused by the focusing lens 108a of the Z scanning section 108, and the focal position can be adjusted in a direction along the optical axis S through the operation of the actuator 108b. Furthermore, as a result of the laser beam passing through the wavefront-disturbing element 110, a spatial disturbance is imparted to the wavefront of the laser beam.

Thereafter, when the laser beam passes through the two pairs of relay lenses 111 and 112 and the XY-scanning section 113, the slope angle of the light beam P is changed while the intermediate image II is being formed, and then the laser beam passes through the dichroic mirror 119. When the laser beam that has passed through the dichroic mirror 119 passes through the wavefront-restoring element 114, the spatial disturbance imparted by the wavefront-disturbing element 110 is cancelled out, and the laser beam is focused by the objective lens 115, thus forming the final image I_{F} in the examination object A.

The focal position of the laser beam, which is the position of the final image I_{F} formed by the image-forming optical system 103, is moved in a direction along the optical axis S by moving the focusing lens 108a through the operation of the actuator 108b. By doing so, the depth of observation for the examination object A can be adjusted. In addition, by swinging the galvanometer mirrors 113a and 113b, the focal position of the laser beam in the examination object A can be two-dimensionally scanned in a direction orthogonal to the optical axis S.

Even if a plurality of intermediate images II are formed by the pairs of relay lenses 111 and 112, the laser beam whose wavefront has been spatially disturbed by the wavefront-disturbing element 110 is subjected to astigmatism in a state where the one light beam P is split into a large number of small light beams by the effect of the lenticular element, namely the cylindrical lens array, constituting the wavefront-disturbing element 110. As a result, the point image, which should in fact be a single image, is made unclear and formed as a collection of many circular images, elliptical images, or line images arranged along a straight line. Then, as a result of the laser beam passing through the wavefront-restoring element 114, the spatial disturbance on the wavefront imparted by the wavefront-disturbing element 110 is cancelled out, and therefore, the final image I_{F}, which is to be formed in the wavefront-restoring element 114 and the subsequent sections, becomes clear.

More specifically, as a result of the intermediate image II being made unclear and blurred, even in a case where the intermediate image II is located in the vicinity of an optical element on the surface or in the interior of which a flaw, foreign object, defect, and so forth are present, it is possible to prevent the flaw, foreign object, defect, and so forth from overlapping the intermediate image II and thus to prevent the final image I_{F} formed in the examination object A from becoming unclear. Consequently, a very small spot can be formed as the final image I_{F}.

In this case, even if the galvanometer mirror 113a on the light source 106 side is swung, the light beam P in the wavefront-restoring element 114, having an optically conjugate positional relationship with this galvanometer mirror 113a, passes through the same area in the direction indicated by arrow X, though the light beam P of the laser beam moves in a one-dimensional linear direction. Therefore, regardless of the galvanometer mirror 113a being swung, it is not necessary to change the phase modulation to be imparted to the laser beam by the wavefront-restoring element 114.

On the other hand, when the galvanometer mirror 113b on the examination object A side is swung, the slope of the light beam P of the laser beam is changed due to the swinging of this galvanometer mirror 113b, thus causing the travel position of the light beam P in the wavefront-restoring element 114 to move in the direction indicated by arrow Y. Because the direction indicated by arrow Y coincides with the direction in which the phase distribution characteristics of the wavefront-restoring element 114 do not change, the imparted phase modulation does not change even if movement of the travel position of the light beam P causes the light beam P to pass through a different area in the wavefront-restoring element 114 in the direction indicated by arrow Y. Therefore, regardless of the galvanometer mirror 113b being swung, it is not necessary to change the phase modulation to be imparted to the laser beam by the wavefront-restoring element 114.

This can be rephrased as follows.

For a structure in which the galvanometer mirrors 113a and 113b are arranged adjacent to each other without placing a pair of relay lenses therebetween, as in this embodiment, there are no optically conjugate positions to both the galvanometer mirrors 113a and 113b. In other words, even if the wavefront-disturbing element 110 and the wavefront-restoring element 114 are arranged at conjugate positions, a positional relationship that would usually ensure that the wavefront-disturbing element 110 and the wavefront-restoring element 114 become complementary to each other is lost due to light scanning in a two-dimensional direction resulting from swinging of the galvanometer mirrors 113a and 113b, thus making it impossible to cancel out with the wavefront-restoring element 114 the wavefront disturbance imparted by the wavefront-disturbing element 110. In this embodiment, however, with the contrived shapes and arrangements of the wavefront-disturbing element 110 and the wavefront-restoring element 114, a positional relationship ensuring that the wavefront-disturbing element 110 and the wavefront-restoring element 114 become complementary to each other is substantially maintained, irrespective of the galvanometer mirrors 113a and 113b being swung, thereby making it possible to completely and always cancel out, with the wavefront-restoring element 114, the wavefront disturbance imparted by wavefront-disturbing element 110.

Then, as a result of a very small spot being formed in the examination object A, fluorescence can be generated with the photon density being increased in a very small area, and thus, the generated fluorescence can be collected by the objective lens 115, split off by the dichroic mirror 119, and guided by the detector optical system 104 to the photodetector 105 to detect the fluorescence.

The intensity of the fluorescence detected by the photodetector 105 is stored in an association with three-dimensional laser-beam scanning positions based on positions in the directions indicated by arrows X and Y determined with the galvanometer mirrors 113a and 113b and a position in a direction along the optical axis S determined with the actuator 108b, whereby a fluorescence image of the examination object A is acquired. In short, because fluorescence is generated in a very small spot area at each scanning position, the observation apparatus 101 of this embodiment affords an advantage in that a fluorescence image with high spatial resolution can be acquired.

In addition, in the observation apparatus 101 according to this embodiment, because it is not necessary to place a pair of relay lenses between the two galvanometer mirrors 113a and 113b, the number of components in the apparatus can be reduced. Furthermore, by employing a structure in which the galvanometer mirrors 113a and 113b are arranged adjacent to each other, without placing a pair of relay lenses, the size of the apparatus can be reduced.

Although lenticular elements are used as examples of the wavefront-disturbing element 110 and the wavefront-restoring element 114 in this embodiment, an element having one-dimensional phase distribution characteristics may be employed instead. For example, a prism array, diffraction grating, or cylindrical lens may be employed.

Furthermore, although the galvanometer mirrors 113a and 113b are used as examples of the first scanner and the second scanner, serving as means for shifting intermediate images on the XY axes, in this embodiment, another type of scanner may be used for one or both of the scanners. For example, a polygon mirror, an AOD (acousto-optic element), or a KTN (potassium tantalate niobate) crystal may be employed.

Furthermore, although a multiphoton-excitation microscope is used as an example of the observation apparatus 101 according to this embodiment, this embodiment may be applied to a confocal microscope instead.

According to this, because a very small spot is formed in the examination object A as the final image I_{F} that has been made clear, fluorescence with an increased photon density can be generated in a very small area, and thus a bright confocal image can be acquired by increasing the amount of fluorescence passing through the confocal pinhole.

It is also acceptable to detect light that has been reflected at or scattered in the examination object A and that has passed through the confocal pinhole, instead of detecting fluorescence passing through the confocal pinhole in a confocal microscope.

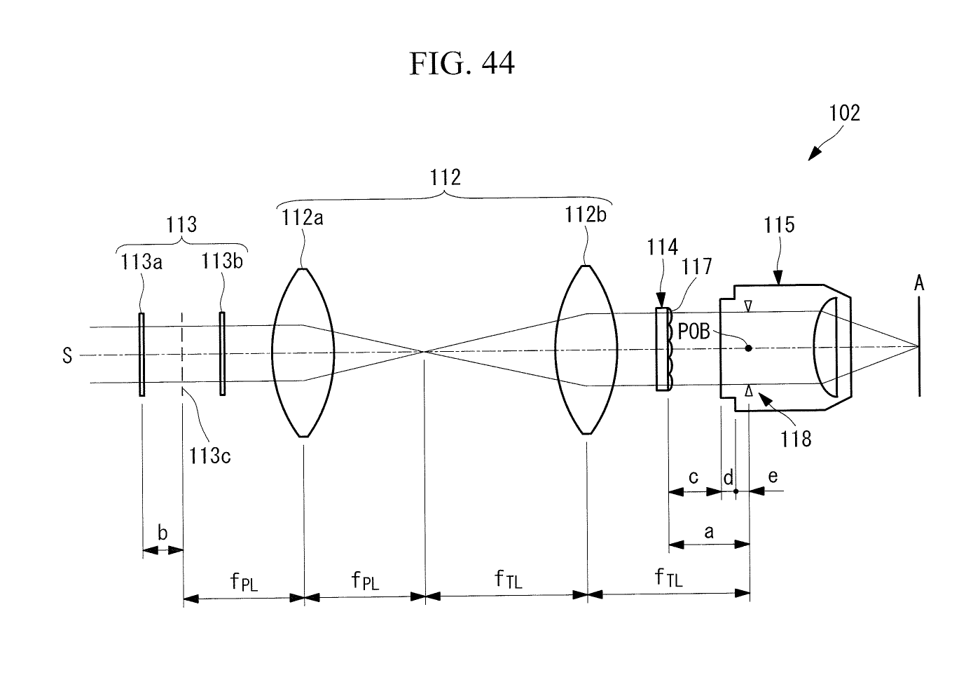

Next, a specific example for optical conditions in the illuminating device 102 according to this embodiment will be described with reference to FIGS. 39 and 44.

In a specific example for optical conditions in the illuminating device 102 according to this embodiment as shown in FIG. 39, the wavefront-disturbing element 110 is placed at an optically conjugate position to the galvanometer mirror 113a on the light source 106 side, and the wavefront-restoring element 114 is placed in the rear of the objective lens 115 at an optically conjugate position to the galvanometer mirror 113a on the light source 106 side. The wavefront-restoring element 114 is placed so that its phase distribution characteristics coincide with the laser-beam scanning direction (direction indicated by arrow X) due to the galvanometer mirror 113a.

According to this method, regardless of the swing angles of the galvanometer mirrors 113a and 113b, the spatial disturbance on the wavefront imparted by the wavefront-disturbing element 110 can always be cancelled out by the wavefront-restoring element 114. Therefore, the intermediate image II is made unclear, whereby the image of a foreign object present at the forming position of the intermediate image II can be prevented from overlapping the intermediate image II, and the final image I_{F} can always be made clear.

Next, a specific example for optical conditions in the illuminating device 102 according to this embodiment will be described on the basis of FIG. 44, with attention focused particularly to the arrangement of each element in the space from the galvanometer mirrors 113a and 113b to the objective lens 115.

The distance a from the pupil position POB of the objective lens 115 to the wavefront-restoring element 114 in FIG. 4 satisfies the conditions in Expression (16).

a=b(f_{TL}/f_{PL})² (16)

Here, b denotes the distance from the position 113c, which is located between the two galvanometer mirrors 113a and 113b and is substantially conjugate to the pupil position POB of the objective lens 115, to the galvanometer mirror 113a on the light source 106 side, f_{PL} denotes the focal length of the lens 112a on the light source 106 side of the pair of relay lenses 112, and f_{TL} denotes the focal length of the lens 112b on the examination object A side of the pair of relay lenses 112. In addition, the distance c from the trailing edge of the mount thread of the objective lens 115 to the wavefront-restoring element 114 satisfies the conditions in Expression (17).

c=a−(d+e) (17)

Here, d denotes the amount of protrusion of the mount thread of the objective lens 115, and e denotes the distance from the shoulder surface of the objective lens 115 to the pupil position POB of the objective lens 115.

The values in this embodiment are as follows.

b=2.7 (mm)

f_{PL}=52 (mm)

f_{TL}=200 (mm)

d=5 (mm)

e=28 (mm)

Therefore, a=39.9 (mm) is calculated from Expression (16), and c=6.9 (mm) is calculated from Expression (17). Consequently, the wavefront-restoring element 114 is placed in the rear of the objective lens 115 at an optically conjugate position to the galvanometer mirror 113a on the light source 106 side, without coming into contact with the trailing edge of the outer frame, namely the mount thread, of the objective lens 115.

According to the above-described aspect relating to the movement of the intermediate image and the final image in the XY-axis directions, the present invention makes microscopic observation even more advantageous when combined with the above-described aspect relating to the movement of the intermediate image and the final image in the Z-axis direction. Therefore, in contrast to the viewpoint of making unclear the intermediate image moving in the Z-axis direction, as referred to in FIGS. 1 through 38, the present invention includes the following supplementary information on the basis of the viewpoint of maintaining a complementary relationship between the wavefront-disturbing element and the wavefront-restoring element for scanning in the XY-axis directions with one pair of galvanometer mirrors that are not arranged in a mutually conjugate manner, as illustrated in FIGS. 39 through 44.

(Supplementary Information 1)

An observation apparatus that is applied to an optical-axis-direction scanning microscope apparatus including: an image-forming optical system provided with a plurality of image-forming lenses for forming a final image and at least one intermediate image, a first phase modulation element that is placed towards the object from one of the intermediate images formed by the image-forming lenses and that imparts a spatial disturbance to the wavefront of the light from the object, and a second phase modulation element that is placed at a position, between that position and the first phase modulation element being at least one intermediate image, and that cancels out the spatial disturbance imparted by the first phase modulation element to the wavefront of the light from the object; a light source that is placed on the object side of the image-forming optical system and that generates illumination light entering the image-forming optical system; a first scanner and a second scanner that are placed in the optical axis direction with a space therebetween and that scan the illumination light from the light source; and a photodetector for detecting the light emitted from the examination object placed at the final-image position of the image-forming optical system, wherein the first phase modulation element and the second phase modulation element are placed at optically conjugate positions to the first scanner placed on the light source side and have one-dimensional phase distribution characteristics that change in a direction coinciding with the illumination-light scanning direction by the first scanner.

(Supplementary Information 2)

An observation apparatus applied to an optical-axis-direction scanning microscope apparatus, wherein the first phase modulation element and the second phase modulation element are placed at optically conjugate positions to a second scanner placed on the object side and have one-dimensional phase distribution characteristics that change in a direction coinciding with the illumination-light scanning direction by the second scanner, and other structures are in accordance with those of the observation apparatus described in supplementary information 1.

(Supplementary Information 3)

The observation apparatus described in supplementary information 1, wherein the first phase modulation element and the second phase modulation element are a lenticular element.

(Supplementary Information 4)

The observation apparatus described in supplementary information 1, wherein the first phase modulation element and the second phase modulation element are a prism array.

(Supplementary Information 5)

The observation apparatus described in supplementary information 1, wherein the first phase modulation element and the second phase modulation element are a diffraction grating.

(Supplementary Information 6)

The observation apparatus described in supplementary information 1, wherein the first phase modulation element and the second phase modulation element are a cylindrical lens.

In addition, according to the above-described supplementary information, the above-described aspects can be summarized as follows.

In short, a technical problem in the above-described supplementary information is to prevent a flaw, foreign object, defect, and so forth on an optical element from overlapping an intermediate image even if the intermediate image is formed at a position coinciding with the optical element, thereby acquiring a clear final image. Furthermore, as shown in FIG. 39, means for solving the technical problem with the above-described supplementary information generally provides the observation apparatus 101 including: an image-forming optical system 103 provided with image-forming lenses 111, 112, and 115 for forming a final image I_{F} and intermediate images II, a first phase modulation element 110 that is placed towards an object from one of the intermediate images II and that imparts a spatial disturbance to the wavefront of light, and a second phase modulation element 114 that is placed towards the final image I_{F} from at least one of the intermediate images II and that cancels out the spatial disturbance imparted to the wavefront of the light; a light source 106 placed on the object side; an XY-scanning section 113 provided with first and second scanners 113a and 113b placed with a space therebetween in the optical axis S direction; and a photodetector 105 for detecting the light, wherein the two phase modulation elements 110 and 114 are placed at optically conjugate positions to the first scanner 113a placed on the light source 106 side and have one-dimensional phase distribution characteristics that change in a direction coinciding with the illumination-light scanning direction by first scanner 113a.

Although the embodiments of the present invention have been described in detail with reference to the drawings, the specific structure is not limited to those of these embodiments but includes design changes etc. that do not depart from the spirit of the present invention. The present invention is not limited to the invention applied to each of the above-described embodiments and modifications but can be applied to, for example, embodiments in which these embodiments and modifications are appropriately combined and is not particularly limited.

In addition, for example, also in the observation apparatus 101, as shown in FIGS. 39 through 44, the wavefront-disturbing element 110 and the wavefront-restoring element 114 may be arranged so as to have a non-conjugate positional relationship. In this case, it is a good idea to employ a cylindrical lens as the wavefront-disturbing element 110 and the wavefront-restoring element 114. It is also a good idea to arrange the first scanner 113a and the wavefront-restoring element 114 in a conjugate manner and arrange the first scanner 113a and the wavefront-disturbing element 110 in a non-conjugate manner. It is also a good idea to employ means for eliminating the difference between the image-forming magnification in the X direction and the image-forming magnification in the Y direction, such as the aspect-ratio conversion optical system 121, the aspect-ratio conversion mechanism 125, and the aspect-ratio conversion circuit 133.

The above-described embodiment leads to the following invention.

One aspect of the present invention is an optical-axis-direction scanning microscope apparatus including: an image-forming optical system including a plurality of image-forming lenses that form a final image and at least one intermediate image, a first phase modulation element that is placed towards an object from one of the intermediate images formed by the image-forming lenses and that imparts a spatial disturbance to a wavefront of light from the object, and a second phase modulation element that is placed at a position, between the position and the first phase modulation element being at least one intermediate image, and that cancels out the spatial disturbance imparted by the first phase modulation element to the wavefront of the light from the object; and a scanning system that scans, in an optical axis direction, an image formed as a result of the wavefront from the object passing through the image-forming optical system.

In this description, two aspects of images are used: one representing “clear image” and the other “unclear image” (or “blurred image”).

First, the term “clear image” indicates an image generated through an image-forming lens in a state where no spatial disturbance is imparted to the wavefront of the light emitted from the object or in a state where a disturbance, once imparted, is cancelled out, the “clear image” having a spatial frequency band determined by the light wavelength and the numerical aperture of the image-forming lens, a spatial frequency band similar thereto, or a desired spatial frequency band according to the purpose.

Then, the term “unclear image” (or “blurred image”) indicates an image generated through an image-forming lens in a state where spatial disturbance is imparted to the wavefront of the light emitted from the object, the “unclear image” having characteristics for substantially preventing a flaw, foreign object, defect, and so forth present on the surface of or in an optical element placed in the vicinity of the image from being formed as the final image.

Unlike just an out-of-focus image, the “unclear image” (or “blurred image”) formed in this manner, including the image at the position at which the image should in fact be formed (i.e., the image forming position as if no spatial disturbance is imparted to the wavefront), does not have a distinct peak in image contrast over a wide area along the optical axis direction. The “unclear image” always exhibits a narrow spatial frequency band, compared with the spatial frequency band of the “clear image.”

The terms “clear image” and “unclear image” (or “blurred image”) as used in this description are based on the concept described above, and the movement of the intermediate images in the Z-axis direction as applied in the present invention means the movement of the intermediate images while they are being blurred. Furthermore, Z-axis scanning is not limited only to the movement of light in the Z-axis direction but may accompany the movement of light in XY, as described below. In addition, the Z-axis direction as used in this description means a direction along the optical axis.

According to this aspect, the light entering from the object side of the image-forming lenses is focused by the image-forming lenses, thereby forming the final image. In this case, a spatial disturbance is imparted to the wavefront of the light through the first phase modulation element placed towards the object from one of the intermediate images, thereby causing the intermediate images to be formed to become blurred. In addition, as a result of the light that has formed the intermediate images passing through the second phase modulation element, the wavefront spatial disturbance imparted by the first phase modulation element is canceled out. Because of this, the final image that is formed in the subsequent sections becomes clear.

In other words, as a result of the intermediate images being blurred, even if some optical element is placed in the intermediate-image position and a flaw, foreign object, defect, and so forth are present on the surface of or in the optical element, it is possible to prevent the occurrence of a disadvantage that the flaw, foreign object, defect, and so forth of the optical element overlap the intermediate images, eventually forming a part of the final image. Furthermore, when this aspect is applied to a microscope optical system, even if an intermediate image made to move in the Z-axis direction by, for example, focusing overlaps a lens located before or after the intermediate image, no noise images, such as images showing a flaw or foreign object on the surface of the lens, a defect in the lens, and so forth, occur on the final image.

In the above-described aspect, the first phase modulation element and the second phase modulation element may be placed at optically conjugate positions.

In the above-described aspect, the first phase modulation element and the second phase modulation element may be placed in the vicinity of pupil positions of the image-forming lenses.

By doing so, the first phase modulation element and the second phase modulation element can be made compact as a result of being placed in the vicinity of the pupil positions free of variations in the light beam.

In addition, in the above-described aspect, optical-path-length changing means capable of changing the optical-path length between two of the image-forming lenses placed at positions between which one of the intermediate images is disposed may be provided.

By doing so, the image-forming position of the final image can be changed easily in the optical axis direction by changing the optical-path length between the two image-forming lenses through the operation of the optical-path-length changing means.

Furthermore, in the above-described aspect, the optical-path-length changing means may be provided with: a plane mirror that is placed orthogonal to the optical axis and that reflects the light for forming the intermediate images so as to be folded back; an actuator that moves the plane mirror in the optical axis direction; and a beam splitter that splits into two directions the light reflected by the plane mirror.

By doing so, the light from the object side focused by the image-forming lens on the object side is reflected and folded back at the plane mirror, split off by the beam splitter, and enters the image-forming lens on the image side. In this case, the optical-path length between the two image-forming lenses can easily be changed by operating the actuator to move the plane mirror in the optical axis direction, thereby allowing the image-forming position of the final image to be easily changed in the optical axis direction.

Also in the above-described aspect, a variable spatial phase modulation element that changes the position of the final image in the optical axis direction by changing a spatial phase modulation to be imparted to the wavefront of light may be provided in the vicinity of a pupil position of one of the image-forming lenses.

By doing so, a spatial phase modulation that changes the position of the final image in the optical axis direction can be imparted to the wavefront of the light with the variable spatial phase modulation element. The image-forming position of the final image can easily be changed in the optical axis direction by adjusting the phase modulation to be imparted.

Furthermore, in the above-described aspect, a function of at least one of the first phase modulation element and the second phase modulation element may be performed by the variable spatial phase modulation element.

By doing so, the variable spatial phase modulation element can have both the spatial phase modulation that changes the position of the final image in the optical axis direction and the phase modulation for blurring the intermediate images or the phase modulation for canceling out the blurring of the intermediate images. By doing so, the number of component parts can be reduced, thereby making it possible to configure a simple image-forming optical system.

Furthermore, in the above-described aspect, the first phase modulation element and the second phase modulation element may impart to the wavefront of the light phase modulation that changes in a one-dimensional direction orthogonal to the optical axis.

By doing so, the intermediate images can be made to blur by using the first phase modulation element to impart to the wavefront of the light a phase modulation that changes in a one-dimensional direction orthogonal to the optical axis. Then, even if some optical element is placed in the intermediate-image position and a flaw, foreign object, defect, and so forth are present on the surface of or in the optical element, it is possible to prevent the occurrence of a disadvantage in that the flaw, foreign object, defect, and so forth of the optical element overlap the intermediate images, eventually forming a part of the final image. In addition, a clear final image, free of blurring, can be formed by using the second phase modulation element to impart to the wavefront of the light a phase modulation for canceling out the phase modulation that has changed in the one-dimensional direction.

Furthermore, in the above-described aspect, the first phase modulation element and the second phase modulation element may impart, to the wavefront of a light beam, phase modulation that changes in two-dimensional directions orthogonal to the optical axis.

By doing so, the intermediate images can be made to blur more reliably by using the first phase modulation element to impart, to the wavefront of the light, a phase modulation that changes in the two-dimensional directions orthogonal to the optical axis. In addition, a clearer final image can be formed by using the second phase modulation element to impart, to the wavefront of the light, a phase modulation for canceling out the phase modulation that has changed in the two-dimensional directions.

Furthermore, in the above-described aspect, the first phase modulation element and the second phase modulation element may be transmissive elements that impart the phase modulation to the wavefront when transmitting light.

In addition, in the above-described aspect, the first phase modulation element and the second phase modulation element may be reflective elements that impart the phase modulation to the wavefront when reflecting light.

In addition, in the above-described aspect, the first phase modulation element and the second phase modulation element may have complementary shapes.

By doing so, the first phase modulation element that imparts to the wavefront a spatial disturbance for blurring the intermediate images and the second phase modulation element that imparts a phase modulation for canceling out the spatial disturbance imparted to the wavefront can be easily configured.

Furthermore, in the above-described aspect, the first phase modulation element and the second phase modulation element may impart the phase modulation to the wavefront by means of refractive index profiles of transparent materials.

By doing so, a wavefront disturbance in accordance with the refractive index profile can be produced when light passes through the first phase modulation element, and a phase modulation that cancels out the wavefront disturbance in accordance with the refractive index profile can be imparted to the wavefront of the light when the light passes through the second phase modulation element.

Furthermore, in the above-described aspect, a light source that is placed on the object side of the image-forming optical system and that generates illumination light entering the image-forming optical system may be provided.

According to this aspect, when the illumination light emitted from the light source placed on the object side enters the image-forming optical system, the illumination object placed on the final image side can be irradiated with the illumination light. In this case, the intermediate images formed by the image-forming optical system are blurred through the first phase modulation element, and therefore, even if some optical element is placed in the intermediate-image position and a flaw, foreign object, defect, and so forth are present on the surface of or in the optical element, it is possible to prevent the occurrence of a disadvantage in that the flaw, foreign object, defect, and so forth of the optical element overlap the intermediate images, eventually forming a part of the final image.

Furthermore, in the above-described aspect, a photodetector that is placed on the final image side of the image-forming optical system and that detects light emitted from an examination object may be provided.

According to this aspect, it is possible to detect with the photodetector a clear final image that has been formed by the image-forming optical system that prevents the image of a flaw, foreign object, defect, and so forth present on the surface of or in the optical element from overlapping the intermediate images.

In the above-described aspect, the photodetector may be an image-capturing element that is placed at the position of the final image of the image-forming optical system and that acquires the final image.

By doing so, a clear final image can be acquired with the image-capturing element placed at the position of the final image of the image-forming optical system, thereby allowing observation with high accuracy.

Furthermore, in the above-described aspect, a light source that is placed on the object side of the image-forming optical system and that generates illumination light entering the image-forming optical system, as well as a photodetector that is placed on the final image side of the image-forming optical system and that detects light emitted from an examination object, may be provided.

According to this aspect, the light from the light source is focused by the image-forming optical system and radiated on the examination object, and the light generated on the examination object is detected by the photodetector placed on the final image side. By doing so, it is possible to detect with the photodetector a clear final image that has been formed by preventing the image of a flaw, foreign object, defect, and so forth present on the surface of or in the intermediate optical element from overlapping the intermediate images.

In the above-described aspect, a Nipkow disk confocal optical system that is placed between the light source and the photodetector and the image-forming optical system may be provided.

By doing so, the examination object can be scanned with multi-point spotlight, thereby allowing a sharp image of the examination object to be acquired at high speed.

Furthermore, in the above-described aspect, the light source may be a laser light source, and the photodetector may include a confocal pinhole and a photoelectric conversion element.

By doing so, the examination object can be observed by means of a clear confocal image without forming the image of a flaw, foreign object, defect, and so forth at the intermediate-image position.

Furthermore, in the above-described aspect, a photodetector that detects light emitted from an examination object illuminated by the light source may be provided, and the light source may be a pulsed laser light source.

By doing so, the examination object can be observed by means of a clear multiphoton-excitation image without forming the image of a flaw, foreign object, defect, and so forth at the intermediate-image position.

In the above-described aspect, an optical scanner may be provided, wherein the optical scanner may be placed at an optically conjugate position to the first phase modulation element, the second phase modulation element, and pupils of the image-forming lenses.

Furthermore, in the above-described aspect, the first phase modulation element and the second phase modulation element may be combinations of cylindrical lenses that are placed at optically non-conjugate positions.

More specifically, regardless of the first phase modulation element and the second phase modulation element being placed in an optically non-conjugate manner, the disturbance on the wavefront of the light caused by the first phase modulation element can be cancelled out with the second phase modulation element by placing cylindrical lenses having appropriate refractive power at appropriate locations, thereby forming an image without astigmatism. By doing so, even in an optical system in which the first phase modulation element and the second phase modulation element cannot be placed in an optically conjugate manner due to, for example, spatial constraints, the intermediate images can be blurred, thereby making it possible to prevent the occurrence of a disadvantage that a flaw, foreign object, defect, and so forth present on the surface or in an optical element placed at the intermediate-image position overlap the intermediate image and are eventually formed as a part of the final image.

In the above-described aspect, at least one of the first phase modulation element and the second phase modulation element may be placed in the vicinity of pupil positions of the image-forming lenses.

In the above-described aspect, optical-path-length changing means capable of changing the optical-path length between two of the image-forming lenses placed at positions between which one of the above-described intermediate images is disposed may be provided.

In the above-described aspect, the optical-path-length changing means may include: a plane mirror that is placed orthogonal to the optical axis and that reflects the light for forming the intermediate images so as to be folded back; an actuator that moves the plane mirror in the optical axis direction; and a beam splitter that splits into two directions the light reflected by the plane mirror.

In the above-described aspect, a variable spatial phase modulation element that changes the position of the final image in the optical axis direction by changing the spatial phase modulation to be imparted to the wavefront of the light may be provided in the vicinity of the pupil position of one of the image-forming lenses.

In the above-described aspect, a function of at least one of the first phase modulation element and the second phase modulation element may be performed by the variable spatial phase modulation element.

In the above-described aspect, the first phase modulation element and the second phase modulation element may be transmissive elements that impart the phase modulation to the wavefront when transmitting light.

In the above-described aspect, the first phase modulation element and the second phase modulation element may be reflective elements that impart the phase modulation to the wavefront when reflecting light.

In the above-described aspect, the first phase modulation element and the second phase modulation element may have complementary shapes.

In the above-described aspect, the first phase modulation element and the second phase modulation element may impart the phase modulation to the wavefront by means of refractive index profiles of transparent materials.

In the above-described aspect, a light source that is placed on the object side of the image-forming optical system and that generates illumination light entering the image-forming optical system may be further provided.

In the above-described aspect, a photodetector that is placed on the final image side of the image-forming optical system and that detects light emitted from an examination object may be further provided.

In the above-described aspect, the photodetector may be an image-capturing element that is placed at a position of the final image of the image-forming optical system and that acquires the final image.

In the above-described aspect, a light source that is placed on the object side of the image-forming optical system and that generates illumination light entering the image-forming optical system, as well as a photodetector that is placed on the final image side of the image-forming optical system and that detects light emitted from an examination object, may be further provided.

In the above-described aspect, a Nipkow disk confocal optical system that is placed between the light source and the photodetector and the image-forming optical system may be provided.

In the above-described aspect, the light source may be a laser light source, and the photodetector may include a confocal pinhole and a photoelectric conversion element.

In the above-described aspect, a photodetector that detects light emitted from an examination object illuminated by the light source may be provided, and the light source may be a pulsed laser light source.

In the above-described aspect, an optical scanner may be provided, wherein the optical scanner may be placed at an optically conjugate position to the first phase modulation element, the second phase modulation element, and pupils of the image-forming lenses.

### REFERENCE SIGNS LIST

I Final image
II Intermediate image
O Object
PP_{O}, PP_{I} Pupil position
1, 13, 32, 42 Image-forming optical system
2, 3 Image-forming lens
5 Wavefront-disturbing element (first phase modulation element)
6 Wavefront-restoring element (second phase modulation element)
10, 30, 40, 50, 60 Observation apparatus
11, 31, 41 Light source
14, 33 Image-capturing element (photodetector)
17, 23 Phase modulation element
20, 36 Beam splitter
22 Optical-path-length changing means
22a Plane mirror
22b Actuator
34 Nipkow disk confocal optical system
43 Confocal pinhole
44 Photodetector (photoelectronic conversion element)
61a Lens (optical-path-length changing means)
62 Actuator (optical-path-length changing means)
64 Spatial light modulation element (variable spatial phase modulation element)
101 Observation apparatus
103 Image-forming optical system
105 Photodetector
106 Ultra-short pulsed laser beam (light source)
110 Wavefront-disturbing element (first phase modulation element)
111, 112 Pair of relay lenses (image-forming lenses)
113 XY scanning section
113a Galvanometer mirror (first scanner)
113b Galvanometer mirror (second scanner)
114 Wavefront-restoring element (second phase modulation element)
115 Objective lens (image-forming lens)

1. An optical-axis-direction scanning microscope apparatus comprising:
an image-forming optical system including a plurality of image-forming lenses that form a final image and at least one intermediate image, a first phase modulation element that is placed towards an object from one of the intermediate images formed by the image-forming lenses and that imparts a spatial disturbance to a wavefront of light from the object, and a second phase modulation element that is placed at a position, between the position and the first phase modulation element being at least one intermediate image, and that cancels out the spatial disturbance imparted by the first phase modulation element to the wavefront of the light from the object; and
a scanning system that scans, in an optical axis direction, an image formed as a result of the wavefront from the object passing through the image-forming optical system.

2. The optical-axis-direction scanning microscope apparatus according to claim 1, wherein the first phase modulation element and the second phase modulation element are placed at optically conjugate positions.

3. The optical-axis-direction scanning microscope apparatus according to claim 1, wherein the first phase modulation element and the second phase modulation element are placed in the vicinity of pupil positions of the image-forming lenses.

4. The optical-axis-direction scanning microscope apparatus according to claim 1, comprising: optical-path-length changing means capable of changing the optical-path length between two of the image-forming lenses placed at positions between which one of the intermediate images is disposed.

5. The optical-axis-direction scanning microscope apparatus according to claim 4, wherein the optical-path-length changing means includes: a plane mirror that is placed orthogonal to the optical axis and that reflects the light for forming the intermediate images so as to be folded back; an actuator that moves the plane mirror in the optical axis direction; and a beam splitter that splits into two directions the light reflected by the plane mirror.

6. The optical-axis-direction scanning microscope apparatus according to claim 1, comprising: in the vicinity of a pupil position of one of the image-forming lenses, a variable spatial phase modulation element that changes a position of the final image in the optical axis direction by changing a spatial phase modulation to be imparted to the wavefront of light.

7. The optical-axis-direction scanning microscope apparatus according to claim 6, wherein a function of at least one of the first phase modulation element and the second phase modulation element is performed by the variable spatial phase modulation element.

8. The optical-axis-direction scanning microscope apparatus according to claim 1, wherein the first phase modulation element and the second phase modulation element impart to the wavefront of a light beam a phase modulation that changes in a one-dimensional direction orthogonal to the optical axis.

9. The optical-axis-direction scanning microscope apparatus according to claim 1, wherein the first phase modulation element and the second phase modulation element impart, to the wavefront of a light beam, phase modulation that changes in two-dimensional directions orthogonal to the optical axis.

10. The optical-axis-direction scanning microscope apparatus according to claim 1, wherein the first phase modulation element and the second phase modulation element are transmissive elements that impart the phase modulation to the wavefront when transmitting light.

11. The optical-axis-direction scanning microscope apparatus according to claim 1, wherein the first phase modulation element and the second phase modulation element are reflective elements that impart the phase modulation to the wavefront when reflecting light.

12. The optical-axis-direction scanning microscope apparatus according to claim 1, wherein the first phase modulation element and the second phase modulation element have complementary shapes.

13. The optical-axis-direction scanning microscope apparatus according to claim 10, wherein the first phase modulation element and the second phase modulation element impart the phase modulation to the wavefront by means of refractive index profiles of transparent materials.

14. The optical-axis-direction scanning microscope apparatus according to claim 1, further comprising: a light source that is placed on the object side of the image-forming optical system and that generates illumination light entering the image-forming optical system.

15. The optical-axis-direction scanning microscope apparatus according to claim 1, further comprising: a photodetector that is placed on the final image side of the image-forming optical system and that detects light emitted from an examination object.

16. The optical-axis-direction scanning microscope apparatus according to claim 15, wherein the photodetector is an image-capturing element that is placed at a position of the final image of the image-forming optical system and that acquires the final image.

17. The optical-axis-direction scanning microscope apparatus according to claim 1, further comprising: a light source that is placed on the object side of the image-forming optical system and that generates illumination light entering the image-forming optical system; and a photodetector that is placed on the final image side of the image-forming optical system and that detects light emitted from an examination object.

18. The optical-axis-direction scanning microscope apparatus according to claim 17, comprising: a Nipkow disk confocal optical system that is placed between the light source and the photodetector and the image-forming optical system.

19. The optical-axis-direction scanning microscope apparatus according to claim 17, wherein the light source is a laser light source, and
the photodetector includes a confocal pinhole and a photoelectric conversion element.

20. The optical-axis-direction scanning microscope apparatus according to claim 14, comprising: a photodetector that detects light emitted from an examination object illuminated by the light source,
wherein the light source is a pulsed laser light source.

21. The optical-axis-direction scanning microscope apparatus according to claim 19, comprising: an optical scanner,
wherein the optical scanner is placed at an optically conjugate position to the first phase modulation element, the second phase modulation element, and pupils of the image-forming lenses.

22. The optical-axis-direction scanning microscope apparatus according to claim 1, wherein the first phase modulation element and the second phase modulation element are combinations of cylindrical lenses that are placed at optically non-conjugate positions.

23. The optical-axis-direction scanning microscope apparatus according to claim 22, wherein at least one of the first phase modulation element and the second phase modulation element is placed in the vicinity of pupil positions of the image-forming lenses.

24. The optical-axis-direction scanning microscope apparatus according to claim 22, comprising: optical-path-length changing means capable of changing the optical-path length between two of the image-forming lenses placed at positions between which one of the intermediate images is disposed.

25. The optical-axis-direction scanning microscope apparatus according to claim 24, wherein the optical-path-length changing means includes: a plane mirror that is placed orthogonal to the optical axis and that reflects the light for forming the intermediate images so as to be folded back; an actuator that moves the plane mirror in the optical axis direction; and a beam splitter that splits into two directions the light reflected by the plane mirror.

26. The optical-axis-direction scanning microscope apparatus according to claim 22, comprising: in the vicinity of a pupil position of one of the image-forming lenses, a variable spatial phase modulation element that changes a position of the final image in the optical axis direction by changing a spatial phase modulation to be imparted to the wavefront of the light.

27. The optical-axis-direction scanning microscope apparatus according to claim 26, wherein a function of at least one of the first phase modulation element and the second phase modulation element is performed by the variable spatial phase modulation element.

28. The optical-axis-direction scanning microscope apparatus according to claim 22, wherein the first phase modulation element and the second phase modulation element are transmissive elements that impart the phase modulation to the wavefront when transmitting light.

29. The optical-axis-direction scanning microscope apparatus according to claim 22, wherein the first phase modulation element and the second phase modulation element are reflective elements that impart the phase modulation to the wavefront when reflecting light.

30. The optical-axis-direction scanning microscope apparatus according to claim 22, wherein the first phase modulation element and the second phase modulation element have complementary shapes.

31. The optical-axis-direction scanning microscope apparatus according to claim 28, wherein the first phase modulation element and the second phase modulation element impart the phase modulation to the wavefront by means of refractive index profiles of transparent materials.

32. The optical-axis-direction scanning microscope apparatus according to claim 22, further comprising: a light source that is placed on the object side of the image-forming optical system and that generates illumination light entering the image-forming optical system.

33. The optical-axis-direction scanning microscope apparatus according to claim 22, further comprising: a photodetector that is placed on the final image side of the image-forming optical system and that detects light emitted from an examination object.

34. The optical-axis-direction scanning microscope apparatus according to claim 33, wherein the photodetector is an image-capturing element that is placed at a position of the final image of the image-forming optical system and that acquires the final image.

35. The optical-axis-direction scanning microscope apparatus according to claim 22, further comprising: a light source that is placed on the object side of the image-forming optical system and that generates illumination light entering the image-forming optical system; and a photodetector that is placed on the final image side of the image-forming optical system and that detects light emitted from an examination object.

36. The optical-axis-direction scanning microscope apparatus according to claim 35, comprising: a Nipkow disk confocal optical system that is placed between the light source and the photodetector and the image-forming optical system.

37. The optical-axis-direction scanning microscope apparatus according to claim 35, wherein the light source is a laser light source, and
the photodetector includes a confocal pinhole and a photoelectric conversion element.

38. The optical-axis-direction scanning microscope apparatus according to claim 32, comprising: a photodetector that detects light emitted from an examination object illuminated by the light source,
wherein the light source is a pulsed laser light source.

39. The optical-axis-direction scanning microscope apparatus according to claim 37, comprising: an optical scanner,
wherein the optical scanner is placed at an optically conjugate position to the first phase modulation element, the second phase modulation element, and pupils of the image-forming lenses.
